(19) United States
(12) Patent Application Publication
(10) Pub. No.: US 2011/0053628 A1
(43) Pub. Date: Mar. 3, 2011

(54) SERVICE PROVIDING SYSTEM AND METHOD IN SATELLITE COMMUNICATION SYSTEM

(75) Inventors: Hee-Wook Kim, Daejeon (KR); Kunseok Kang, Daejeon (KR); Do-Seob Ahn, Daejeon (KR); Ho-Jin Lee, Daejeon (KR)

(73) Assignee: ELECTRONICS AND TELECOMMUNICATIONS RESEARCH INSTITUTE, Daejeon (KR)

(21) Appl. No.: 12/869,186

(22) Filed: Aug. 26, 2010

(30) Foreign Application Priority Data
Aug. 27, 2009 (KR) 10-2009-0079959
May 19, 2010 (KR) 10-2010-0046818

(51) Int. Cl. H04B 7/00

(52) U.S. Cl. 455/509

(57) ABSTRACT

A service providing method in a satellite communication system includes: confirming positions of terminals when the terminals existing within a service area and intended to receive a service is connected to a satellite base station or a complementary terrestrial component; confirming first terminals, which communicate with the satellite base station, and second terminals, which communicate with the complementary terrestrial component, according to the positions of the terminals; allocating resources usable when communicating with the first terminals and resources usable when communicating with the second terminals; and providing a service to the terminals by using the allocated resources through multi-beams of the satellite base station and multi-beams of the complementary terrestrial component.

### CROSS-REFERENCES TO RELATED APPLICATIONS

The present application claims priority of Korean Patent Application Nos. 10-2009-0079959 and 10-2010-0046818, filed on Aug. 27, 2009, and May 19, 2010, respectively, which are incorporated herein by reference in their entirety.

### BACKGROUND OF THE INVENTION

1. Field of the Invention

Exemplary embodiments of the present invention relate to a satellite communication system; and, more particularly, to a service providing system and method which effectively uses limited resources and power to provide a communication service to a multi service area and multiple users in a satellite communication system in which the multi service area and the multiple users exist.

2. Description of Related Art

Regarding the next generation communication systems, much research has been actively conducted to provide services having a variety of quality of service (QoS) to users at high transmission rates. A satellite communication system has been proposed as an example of the next generation communication systems. The satellite communication system provides a service to a multi service area in which a plurality of service areas are implemented. A plurality of users, that is, a plurality of terminals, which exist in the multi service area, receive services having a variety of QoS, which are provided from the satellite communication system at a high speed.

Regarding the satellite communication system, a variety of methods have been proposed to stably provide a large-capacity service having a variety of QoS to terminals existing in a multi service area through available limited resources at a high speed. In particular, a service providing method based on multi-beams has been proposed to increase the total capacity of the satellite communication system when providing a service through the limited resources, and increase the signal transmission efficiency of the communication system, for example, the Effective Isotropic Radiated Power (EIRP) when transmitting signals at limited usable power of the communication satellite system. The satellite communication system providing a service based on multi-beams acquires a diversity gain when providing the service to terminals existing in a multi service area, and the terminals more stably receive the service through the diversity gain.

As described above, however, when the satellite communication system provides a multi-beam based service to the plurality of terminals existing in the multi service area, interference may not only occur among the service areas composing the multi service area, but may also occur among the terminals existing in the multi service area. In particular, when the satellite communication system provides a service by transmitting signals through multi-beams, large interference may occur among terminals existing at the boundary area between the multi-beams, and interference may also occur between the signals transmitted from the satellite communication system and its Complementary Terrestrial Component (CTC). In order to minimize such interference, a method of dividing and using a limited resource, for example, a frequency, for each service area, each terminal, or each multi-beam has been proposed. However, such a method has a problem in that the use efficiency of the limited resource may be lowered.

Furthermore, as a larger number of users request a large-capacity high-speed service, for example, a high-quality multimedia service, the satellite communication system should provide a large-capacity high-speed service through a wideband in correspondence to the users' requests, for example, users' traffic requirements. However, an available resource through which the satellite communication system provides a high-speed service, for example, an allocable frequency bandwidth is limited as described above. Therefore, there is a demand for a method which is capable of providing a large-capacity high-speed service by making the most of the limited allocable bandwidth.

When the satellite communication system provides a large-capacity high-speed service based on multi-beams through the limited allocable frequency bandwidth, there is a demand for a method which can provide a large-capacity high-speed service by minimizing interference occurring in a multi service areas and users, in particular, interference greatly occurring in the boundary area between the multi-beams. Also, when the satellite communication system provides a communication service by using a CTC, there is a demand for a method which can provide large-capacity high-speed service by minimizing interference occurring between a signal transmitted from a satellite base station (BS) of the satellite communication system and a signal transmitted from the CTC. Furthermore, there is a demand for a method which can stably provide large-capacity high-speed service by maximizing the resource use efficiency and the power use efficiency of the satellite communication system when providing a service of the satellite communication system.

### SUMMARY OF THE INVENTION

An embodiment of the present invention is directed to a service providing system and method for providing a communication service in a satellite communication system.

Another embodiment of the present invention is directed to a service providing system and method in a satellite communication system, which provides a service based on multi-beams to a plurality of users existing within a multi service area.

Another embodiment of the present invention is directed to a service providing system and method in a satellite communication system, which minimizes interference occurring in a multi service area and a plurality of users when providing a large-capacity high-speed service based on multi-beams.

Another embodiment of the present invention is directed to a service providing system and method in a satellite communication system, which stably provides a large-capacity high-speed service through limited resources by minimizing interference between boundary areas of multi-beams.

Another embodiment of the present invention is directed to a service providing system and method in a satellite communication system, which minimizes interference of multi-beams by making the most of allocable limited frequency bandwidth through multi-beams.

Another embodiment of the present invention is directed to a service providing system and method in a satellite communication system, which provides a service by minimizing interference between signals transmitted from a plurality of transmitters in order to provide a communication service.

Another embodiment of the present invention is directed to a service providing system and method in a satellite communication system, which efficiently reuses frequencies to minimize interference between signals transmitted to a multi service area and a plurality of users when providing a service through a satellite base station and a CTC.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a service providing method in a satellite communication system includes: confirming positions of terminals when the terminals existing within a service area and intended to receive a service is connected to a satellite base station or a complementary terrestrial component; confirming first terminals, which communicate with the satellite base station, and second terminals, which communicate with the complementary terrestrial component, according to the positions of the terminals; allocating resources usable when communicating with the first terminals and resources usable when communicating with the second terminals; and providing a service to the terminals by using the allocated resources through multi-beams of the satellite base station and multi-beams of the complementary terrestrial component.

In accordance with another embodiment of the present invention, a service providing system in a satellite communication system includes: a plurality of terminals existing within a service area and connecting the satellite communication system to receive a service; a satellite base station configured to support a first communication between the satellite communication system and terminals intended to receive the service within the service area, confirm first terminals performing the first communication according to positions of the terminals, form a first multi-beam for performing the first communication, and provide a service to the first terminals through the first multi-beam as a resource usable when communicating with the first terminals; and a complementary terrestrial component existing within the service area and configured to support a second communication between the terminals and the satellite communication system, confirm second terminals performing the second communication according to positions of the terminals, form a second multi-beam for performing the second communication, and provide a service to the second terminals through the second multi-beam as a resource usable when communicating with the second terminals.

### BRIEF DESCRIPTION OF THE DRAWINGS

FIG. 1 is a diagram schematically illustrating the architecture of a service providing system in a satellite communication system in accordance with an embodiment of the present invention.

FIG. 2 is a diagram schematically illustrating a beam pattern in the satellite communication system in accordance with the embodiment of the present invention.

FIG. 3 is a diagram schematically illustrating another beam pattern in the satellite communication system in accordance with the embodiment of the present invention.

FIG. 4 is a diagram schematically illustrating a frame structure in the satellite communication system in accordance with the embodiment of the present invention.

FIG. 5 is a diagram schematically illustrating another beam pattern in the satellite communication system in accordance with the embodiment of the present invention.

FIG. 6 is a diagram schematically illustrating another frame structure in the satellite communication system in accordance with the embodiment of the present invention.

FIG. 7 is a diagram schematically illustrating another beam pattern in the satellite communication system in accordance with the embodiment of the present invention.

FIG. 8 is a diagram schematically illustrating another beam pattern in the satellite communication system in accordance with the embodiment of the present invention.

FIG. 9 is a diagram schematically illustrating another beam pattern in the satellite communication system in accordance with the embodiment of the present invention.

FIG. 10 is a flowchart schematically illustrating a service providing method in a satellite communication system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Exemplary embodiments of the present invention provide a system and method for providing a communication service in a satellite communication system. Exemplary embodiments of the present invention provide a system and method for providing a communication service through multi-beams to improve the use efficiency of available limited frequency resource and power when providing the communication service and to stably provide the service. Furthermore, exemplary embodiments of the present invention provide a service providing system and method for providing a service based on multi-beams to a plurality of users, that is, a plurality of terminals, which exist within a multi service area including a plurality of service areas. In the exemplary embodiments of the present invention, the following descriptions will be focused on the satellite communication system which provides a service through multi-beams. However, the service providing system and method in accordance with the exemplary embodiments of the present invention may also be applied to other wireless communication systems.

In exemplary embodiments of the present invention, the satellite communication system provides a communication service based on multi-beams to a plurality of terminals existing in a service area, and provides a communication service by using a CTC located within the service area. The satellite communication system provides the communication service while minimizing interference between a signal transmitted from the satellite communication system and a signal transmitted from the CTC. The satellite communication system and the CTC maximize the frequency use efficiency by efficiently reusing the limited frequencies.

Also, in exemplary embodiments of the present invention, when the satellite communication system provides a communication service to a plurality of terminals existing in a service area based on multi-beams by using a CTC, interference between signals transmitted by the satellite communication system, for example, interference between a signal transmitted to the service area by a satellite base station and a signal transmitted to the service area by the CTC, is minimized through a beam division multiple access of the CTC. In addition, the limited available frequencies are efficiently reused. The CTC monitors the signal transmitted to the terminal existing within the service area through a predetermined beam among the multi-beams upon signal transmission of the satellite communication system, confirms information about a usable subcarrier group of the CTC from information about a subcarrier or a subcarrier group used for the signal transmission in the predetermined beam, and transmits the signal by using the confirmed subcarrier group. The satellite base station transmits the information about the subcarrier or the subcarrier group used for the signal transmission in the predetermined beam to the service area through a control channel or a header of a transmission frame upon the signal transmission.

Furthermore, in exemplary embodiments of the present invention, the satellite communication system provides a service to a service area through multi-beams by using a subcarrier or a subcarrier group of an available frequency band. Also, the satellite communication system provides a service to a service area by using a plurality of CTCs existing within the service area. At this time, a subcarrier or a subcarrier group usable in the CTCs, that is, a subcarrier or a subcarrier group unused in signal transmission in the satellite base station, is allocated to the CTCs which generates interference with a signal of the satellite base station. In the satellite communication system, a subcarrier or a subcarrier group used in signal transmission in the satellite base station is allocated to the CTCs which do not generate interference with a signal of the satellite base station.

The CTC confirms whether the signal interference occurs by monitoring the signal transmitted from the satellite base station through the multi-beams, and transmits the signal through a predetermined subcarrier or subcarrier group allocated according to whether the signal interference occurs. The CTC performs a beam division multiple access by setting a plurality of access sections, that is, a plurality of access slots, according to a direction of a beam formed by the array antenna, considering a minimum beam coverage size formed in a service area through its own array antenna.

The access section or the access slot is a space area where the terminals can receive a service according to a beam direction of the multi-beams in a service area where the terminals exist, and the service area is divided into a plurality of access sections or access slots according to the beam direction of the multi-beams formed by the satellite communication system. That is, the access section or the access slot is a division unit of the service area divided by the multi-beams when the satellite communication system in accordance with the embodiment of the present invention provides a service to a service area through the multi-beams by using a CTC. In other words, the access section or the access slot refers to a spatial service area where a service is provided through a single beam.

Also, in exemplary embodiments of the present invention, when the satellite communication system provides a service to the terminals existing a service area based on multi-beams by using a CTC, the service area is divided into a plurality of beam sectors in order to minimize interferences between adjacent beams and interference between signals, and provides a communication service to each divided beam sector through a single beam. In exemplary embodiments of the present invention, the service area is divided into a plurality of beam sectors in correspondence to the multi-beams formed by the satellite communication system in order for providing the service. Then, like the above-described access section or access slots, the service is provided in such a state that a single beam corresponds to a single beam sector in the multi-beams. At this time, the CTC acquires information about a position of a terminal receiving a service by directly performing a first communication with the satellite communication system and the terminal receiving the service through communicating with the CTC among the terminals existing within the plurality of beam sectors, that is, by communicating with the satellite base station of the satellite communication system.

When a Global Positioning System (GPS) is provided in the terminals existing within the beam sectors, the CTC acquires information about positions of the terminals intended to communicate with the CTC through the GPS within the beam sectors. When the terminal intended to communicate with the CTC attempts to perform the communication, the CTC acquires position information through channel information of the terminal. At this time, information about a moving speed of the terminal is also acquired. Also, in the satellite communication system, when a GPS is provided in the terminal existing within the beam sectors, the satellite base station communicating with the terminal acquires the information about the position of the terminal, and the CTC acquires the information about the position of the terminal, which communicates with the satellite base station, from the satellite base station.

After acquiring the information about the positions of the terminals existing within the beam sectors in the above-described manner, the CTC confirms the information about the positions of the terminals, and confirms the terminals existing within in each access slot in order for beam multiple access, that is, the terminal communicating with the satellite base station through the multi-beams and the terminal communicating with the CTC. At this time, when providing the service to the service area through the multi-beams in the above-described manner, the satellite communication system divides the plurality of access slots according to the beam directions of the multi-beams in order to minimize interference between adjacent beams. Then, the beam sectors of the service area are set for each divided access slot. In other words, a service is provided to a single beam sector through a single beam in correspondence to the access slot determined by the beam direction of the single beam among the multi-beams.

Also, after acquiring the information about the positions and the moving speeds of the terminals in the above-described manner, the CTC confirms a channel state of the terminal intended to communicate with the CTC. The CTC determines to provide a communication service to the terminal having a poor channel state or moving at a high speed by covering the terminal with a beam having a large coverage size in the multi-beams, and determines to provide a communication service to the terminal having a good channel state or being fixed or moving at a low speed by covering the terminal with a beam having a small coverage size. That is, the CTC confirms the channel state or the mobility of the terminal through the information about the positions and the moving speeds of the terminals, and determines the coverage size of the beam, that is, the size of the access slot, according to the confirmed channel state or mobility of the terminal.

When the CTC determines and allocates the coverage size of the beam, that is, the access slot of the terminal intended to communicate with the CTC within the beam sector, the terminal directly communicating with the satellite communication system within the allocated access slot, that is, the terminal communicating with the satellite base station, is confirmed to distinguish the terminal communicating with the CTC and the terminal communicating with the satellite base station. When there exists a terminal communicating with the satellite base station at each access slot corresponding to the multi-beams, the CTC attempts to perform a beam division multiple access with respect to the terminal communicating with the CTC. Also, when there exists no terminal communicating with the satellite base station at each access slot, the CTC attempts to perform a beam division multiple access with respect to a terminal which cannot perform a communication with the satellite base station.

In case where the exists the terminal communicating with the satellite base station at each access slot and the beam division multiple access is performed with respect to the terminal intended to communicate with the CTC, the CTC confirms traffic requirements of the terminals intended to perform the communication at each beam sector, that is, a service type wanted to be received, and position, speed or channel information. Then, the CTC selects an optimum terminal by determining a priority according to a channel state or a QoS of terminals using the confirmed information. The CTC supports the beam division multiple access by allocating the access slot to each beam sector according to the channel state of the selected terminal. At this time, in the satellite communication system, the total power of each beam radiated to each beam sector is lower than the maximum usable power of the CTC, and the power and angle of the multi-beams, that is, the power, the coverage size and the beam directions of the multi-beams, are determined to maximize the capacity of all beam accesses in which the terminals existing at each beam sector performs a beam division multiple access.

Also, in case where there exists no terminal communicating with the satellite base station at each access slot and the beam division multiple access is performed with respect to the terminal which cannot communicate with the satellite base station, the CTC confirms the traffic requirements of the terminals intended to perform the communication at each beam sector, that is, the service type wanted to be received, and the position, the speed or the channel information, and selects a predetermined terminal which will perform the communication. At this time, the terminals intended to communicate with the CTC inform the CTC of whether the communication with the satellite base station is possible, that is, whether the signal can be received from the satellite base station, and the CTC deletes the terminals, which can receive the signal from the satellite base station, from a terminal list corresponding to the beam division multiple access. The CTC supports the beam division multiple access by allocating the access slot to each beam sector, considering the channel state of the selected terminal. At this time, as described above, in the satellite communication system, the total power of each beam radiated to each beam sector is lower than the maximum usable power of the CTC, and the power and angle of the multi-beams, that is, the power, the coverage size and the beam directions of the multi-beams, are determined to maximize the capacity of all beam accesses in which the terminals existing at each beam sector performs a beam division multiple access.

Furthermore, in exemplary embodiments of the present invention, the satellite communication system provides a service to a service area by using a plurality of CTCs existing within the service area. When several CTCs among the plurality of CTCs are located adjacently within the service area, the adjacent CTCs share information about the access slots upon the beam division multiple access, and support the beam division multiple access through the access slots unused at the adjacent beam sectors, that is, the different access slots at the adjacent beam sectors corresponding to the adjacent CTCs, by using the information about the access slots in order to minimize interference between signals transmitted from the adjacent CTCs. In such a satellite communication system providing the service to the service area by using the plurality of CTCs, the total power of each beam radiated to each beam sector is lower than the maximum usable power of the CTCs, and the power and angle of the multi-beams, that is, the power, the coverage size and the beam directions of the multi-beams, are determined to maximize the capacity of all beam accesses in which the terminals existing at each beam sector performs a beam division multiple access.

That is, in exemplary embodiments of the present invention, the satellite communication system provides a service to a plurality of terminals within a service area, based on multi-beams, by using a plurality of CTCs. At this time, the satellite communication system supports a beam division multiple access to CTCs to satisfy a QoS requested by the terminal users, maximize the use efficiency of the available frequency resources and power, and minimize interference between signals transmitted from the satellite communication system, that is, interference between signals transmitted from a satellite base station and signals transmitted from the CTCs.

In exemplary embodiments of the present invention, when the satellite communication system provides a service to a service area, based on multi-beams, the service area is divided into a plurality of beam sectors, and a frequency reuse factor in the service area is set to 1. That is, the service is provided through the multi-beams by allocating frequency bands having the same center frequency (fc) to the divided beam sectors. The satellite communication system provides a service through a time multiplexing scheme or a frequency multiplexing scheme in order to minimize interference between multi-beams when providing the service by setting the frequency reuse factor to 1 to maximize the frequency reuse rate.

In other words, in the exemplary embodiments of the present invention, when the satellite communication system transmits a signal to terminals existing in the center areas and the boundary areas of the multi-beams through time multiplexing to provide a communication service, the signal transmission period to the terminals existing in the center areas of the multi-beams may be frequency-multiplexed, and the signal may be transmitted to the terminals existing in the center areas and the boundary areas through the frequency multiplexing. In this case, a CTC serving as a repeater to relay signals between the satellite base station and the terminals transmits the signal to the terminals by using the same subcarrier group in the same frequency band as the frequency band used by the satellite base station. At this time, the CTC does not interfere in the signals transmitted by the satellite base station and the terminals.

In the exemplary embodiments of the present invention, when the satellite communication system using a frequency reuse factor of 1 based on Orthogonal Frequency Division Multiple Access (OFDMA) forms the multi-beams to provide a communication service, the satellite communication system uses the frequency reuse factor of 1 in the center areas of beams, and partially reuses a plurality of frequency band groups in the edge areas of beams. The satellite communication system divides the frequency band groups used in the multi-beams into subcarrier groups in the edge areas of beams. The satellite communication system provides a service by using the subcarrier group unused in the edge areas of the adjacent beams, that is, by using the different subcarrier groups in the edge areas of the adjacent beams.

Examples of the satellite communication system in accordance with the embodiments of the present invention may include a satellite communication system using a CTC such as a repeater, a Complementary Ground Component (CGC), and an Ancillary Terrestrial Component (ATC). Also, examples of the satellite communication system may include a Digital Multimedia Broadcasting (DMB) system or a Digital Video Broadcasting-Satellite services to Handhelds (DVB-SH) system for providing a broadcasting service, and a terrestrial satellite integrated system of Mobile Satellite Ventures (MSV) and TerreStar as a Mobile satellite service (MSS) system for providing voice and data communications in urban areas and suburbs using the ATC.

The satellite DMB system is designed to additionally adopt a terrestrial network using both a satellite and the same channel gap filler to thereby enable a user to receive enhanced audio signals and multimedia signals using a receiver for a vehicle, a fixed terminal, or a mobile terminal. The satellite DMB system may be optimized in a band of 2,630 MHz to 2,655 MHz of the satellite and a terrestrial part. The satellite DMB system may include a feeder link earth station, a broadcasting satellite, two types of terrestrial repeaters, and a receiver, for example, a receiver for a vehicle, a fixed terminal, or a mobile terminal. Signals may be transmitted to the satellite via the feeder link earth station. In this instance, a Fixed Satellite Service (FSS) band, for example, 14 GHz may be used for an upward link. The received signals may be converted to the band of 2.6 GHz in the satellite, and amplified to a desired level through an amplifier of a satellite repeater and thereby be broadcast to a service area. A terminal which is to receive the broadcasting service from the satellite DMB system may need to receive signals via a miniature antenna with a low directivity. To this end, there is a need for a sufficient level of Effective Isotropic Radiated Power (EIRP). Therefore, the satellite DMB system may need to include a large transmission antenna and a high power repeater. Major shortcomings found from signal propagation in the band of 2.6 GHz may include an obstacle in a direct path from the satellite, and a shadowing. To overcome the shortcomings, a repeater to retransmit a satellite signal is added in a system design. This repeater is in charge of a portion occluded by an obstacle, for example, a building and the like. The repeater may be classified into a direct amplification repeater and a frequency converting repeater. The direct amplification repeater simply amplifies a broadcast signal of 2.6 GHz. Generally, a low gain amplifier may be used to avoid an unnecessary emission caused by signal interference between a receive antenna and a transmit antenna. The low gain amplifier is in charge of a relatively small region of up to 500 m based on a Line of Sight (LOS). The frequency converting repeater is in charge of a relatively large region of up to 3 km, and may convert the received signal of 2.6 GHz to a signal of a different frequency band, for example, 11 GHz and thereby transmit the converted signal. In this environment, a multi-path fading phenomenon where at least two signals are received may occur. In order to stably receive a multi-path fading signal, the satellite DMB system may use a rake receiver that is applied with a Code Division Multiplexing (CDM) technology.

The DVB-SH system countries may be a system that uses a satellite in the nationwide coverage and also uses a CGC in an indoor environment or a terrestrial coverage. The DVB-SH system aims to provide a mobile TV service in the bandwidth of 15 MHz of S band based on DVB-H. Since a band adjacent to a terrestrial International Mobile Telecommunication (IMT) band of the S band is used, the integration with a terrestrial IMT part may be readily performed. In addition, the terrestrial network may also be easily reused and thus costs may be reduced. The DVB-SH system considers a hybrid broadcasting structure with the terrestrial network. Also, in order to decrease signal interference between the satellite and the CGC, and to effectively use frequency resources, the DVB-SH system considers a structure where a frequency reuse factor is set to 1 with respect to a CGC cell within a single satellite spot beam, and a frequency reuse factor is set to 3 with respect to the satellite spot beam. In this case, it is possible to broadcast, using the satellite spot beam, nine TV channels covering the entire nation, or to broadcast 27 channels via the terrestrial repeater in an urban area or in an indoor environment.

The terrestrial satellite integrated system of MSV and TerreStar using the ATC is a geostationary orbit (GEO) based mobile satellite communication system to provide a terminal with a ubiquitous wireless wide area network service such as an Internet access, a voice communication, and the like in L band and S band. By using a hybrid radio network structure where a satellite and an ATC are integrated, the GEO-mobile satellite communication system may provide a voice service or a high speed packet service via the ATC, that is, a terrestrial network in urban areas or populated areas, and may also provide a service via the satellite in suburbs or countryside not covered by the ATC. The ATC is in development to provide a satellite service without significantly increasing a complexity of a terrestrial terminal using a radio interface similar to a radio interface of the satellite, and the like.

The satellite communication system in accordance with the embodiments of the present invention may be a personal mobile satellite communication system. The personal mobile satellite communication system may be configured to provide a service via a satellite in suburbs or countryside where a LOS is guaranteed, and to provide the service via an ATC in urban areas or indoor environments where a satellite signal is not guaranteed. At this time, the satellite communication system improves the spectrum use efficiency and the power use efficiency of the multi-beams in consideration of a communication environment in which the communication service is provided via the ATC and a communication environment in which the communication service is provided via the satellite. Furthermore, the satellite communication system stably provides the communication service in correspondence to traffic requirements of users to receive the communication service in the multi-service area.

That is, in the exemplary embodiments of the present invention, the satellite communication system provides a wideband service according to the increase in requirements of providing a high-quality multimedia service. In the satellite communication system, the available frequency bands for providing the service, for example, a 30 MHz band of a 1,980-2,010 MHz uplink and a 2,170-2,200 MHz downlink is allocated. In order to provide a wideband service at such a frequency band, if setting a frequency reuse factor to 3 or 7 under an environment where a wireless interface having a bandwidth of at least 10 MHz or more is considered, it is difficult to provide a wideband service using the available frequency band. Thus, the satellite communication system in accordance with the embodiment of the present invention provides a wideband service by setting the frequency reuse factor to 1. At this time, the satellite communication system maximizes the spectrum use efficiency and the frequency use efficiency by setting the frequency reuse factor to 1 with respect to the available frequency band by using the CTC based on the multi-beams, and then provides the service. In the following exemplary embodiments of the present invention, the service is provided to the service areas by minimizing interference between the signals transmitted by the satellite base station and the CTC to the service area through the multi-beams by setting the frequency reuse factor to 1.

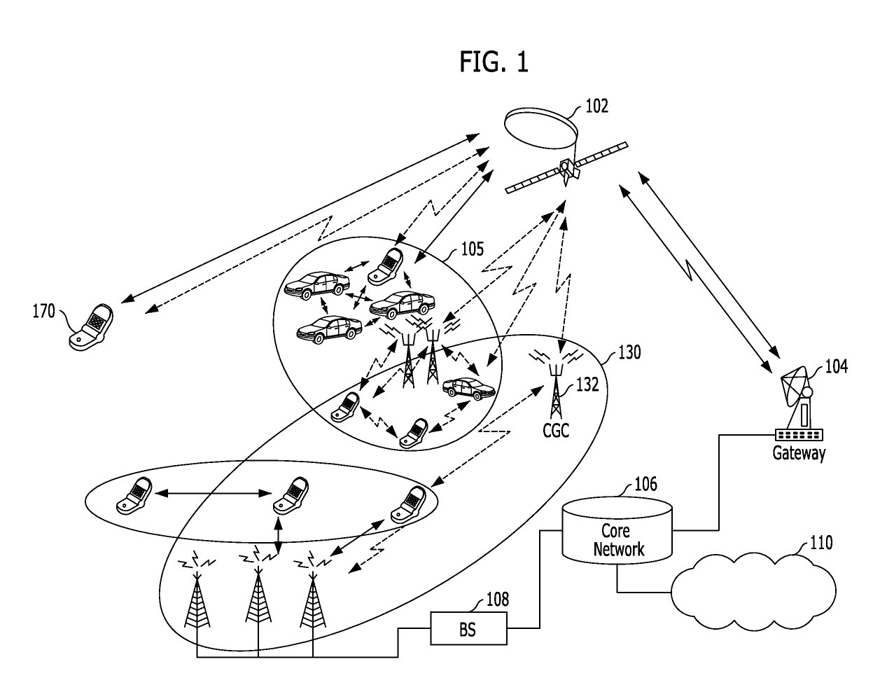

The satellite communication system in accordance with the embodiments of the present invention monitors instant traffic requirements of users existing in the entire satellite coverage, and forms multi-beams having various coverage sizes corresponding to the traffic requirements. Then, when providing the service through the multi-beams formed with the various coverage sizes, the satellite communication system provides a communication service by effectively reusing the frequency to minimize the interference between the signal transmitted through the multi-beams by the satellite communication system and the signal transmitted through the multi-beams by the CTC. In the following embodiments of the present invention, the satellite communication system has commonality with various types of terrestrial communication systems. The satellite communication system may transmit and receive signals to and from all terrestrial systems, regardless of access standards such as OFDMA, Code Division Multiple Access (CDMA), and Time Division Multiple Access (TDMA), and may provide a communication service by using multi spot beams. Hereinafter, a service providing system in a communication system in accordance with an embodiment of the present invention will be described in detail with reference to FIG. 1.

FIG. 1 is a diagram schematically illustrating the architecture of a service providing system in a satellite communication system in accordance with an embodiment of the present invention.

Referring to FIG. 1, the service providing system in the satellite communication system includes a satellite 102, a first terminal 170, a gateway 104, a core network 106, an access network 110, a base station (BS) 108, a CGC 132, and a plurality of terminals. The satellite 102 is a satellite BS configured to provide a communication service by using multi-beams. The first terminal 170 is located in a suburb to receive the communication service from the satellite 102. The gateway 104 is configured to connect signal transmission/reception between the satellite 102 and a terrestrial system. The core network 106 is included in the terrestrial system and configured to transmit/receive a signal to/from the satellite 102 through the gateway 104. The access network 110 is connected to the core network 106 to provide the communication service. The BS 108 is connected to the core network 106 to provide the communication service to other terminals included in the terrestrial system and performs a function of a BS or a control station which controls a BS. The CGC 132 is a complementary terrestrial component of the satellite 102 and provides the communication service to the terminals existing in a service area 130 of an urban area. The terminals are located in a boundary area between the suburb and the urban area and receive the communication service from the satellite 102.

In this embodiment, the satellite 102 serving as the satellite BS may be a GEO satellite which supports and executes a direct communication between the terminals existing within the service area and the satellite communication system and transmits a signal through the multi-beams. For convenience of explanation, a case where only one satellite exists will be described below. However, other types of satellites as well as a plurality of GEO satellites may exist to provide the communication service. Such satellites provide the communication service to terminals by using a mono-beam or multi-beams. Also, for convenience of explanation, although it will be described in the following embodiments that the satellite communication system forms the multi-beams and provides the communication service to the terminals existing within the service area by allocating resources and powers of the formed multi-beams, the satellite BS of the satellite communication system, for example, the satellite 102, forms the multi-beams and allocates the resources and powers.

In other words, the satellite BS of the satellite communication system monitors the distribution and traffic volume of the terminals existing within the service area, and forms multi-beams for each coverage size in order to cover the coverage size corresponding to the monitored distribution and traffic volume of the terminals. Then, the satellite BS allocates the resource and power corresponding to each multi-beam in order to provide the communication service to the terminals by transmitting data traffics through the formed multi-beams, and provides the communication service to the terminals by using the multi-beams through the allocated resource and power. At this time, the satellite BS minimizes interference between the multi-beams when providing the communication service while satisfying the QoS, and minimizes interference between the signal transmitted from the satellite BS and the signal transmitted from the CTC. Also, the satellite BS maximizes the frequency use efficiency and the power use efficiency by setting a frequency reuse factor to 1. For convenience of explanation, it will be assumed that the satellite communication system performs the operation of the satellite BS.

An area where the terminals are located may be a single access slot area or a plurality of access slot group areas by roaming of the terminal. The terminals include in the terrestrial system receive a communication service by connection to a network of the gateway 104 connected to at least one satellite. At this time, the satellite 102 communicates with the terrestrial system, the communication devices included in the terrestrial system, and the CTCs through an interface corresponding to an access standard of the terrestrial system. For convenience of explanation, it will be assumed in the following embodiment that the satellite 102 communicates with the terrestrial system and other devices by using an OFDMA-based satellite radio interface.

In addition, the gateway 104 is a centralized gateway or one gateway of a geographically distributed gateway group according to requirements of the satellite communication system or the operator of the satellite communication system. The gateway 104 is connected to the BS 108, which is a subsystem connected to the core network 106 or the access network 110, and transmits/receives a signal. As described above, the BS 108 performs the same functions as those of a BS and a control station used in a terrestrial network. The BS 108 exists inside the gateway 104 or exists outside the gateway 104 as illustrated in FIG. 1.

The satellite communication system reuses the same frequency as that of the satellite 102 by using a CTC such as a CGC 132 in order for coverage continuity in a shadow area generated due to buildings or mountains during signal transmission in the service area of the urban area. Then, the satellite communication system amplifies a satellite signal of the satellite 102 through the reused frequency and transmits the amplified satellite signal to the terminals existing within the service area 130. That is, the satellite communication system provides a broadcast service or a multimedia broadcast multicast service (MBMS) through the satellite 102 or the CTC to the terminals included in the terrestrial system as well as the suburb and the urban area.

The satellite communication system provides the MBMS through the satellite 102 in a nationwide coverage such as a suburbs or a rural area where a line of sight (LoS) is guaranteed, and provides the MBMS through the CTC, e.g., the CGC 132, in the service area 130 of an urban area or indoor environment where a satellite signal is not received due to buildings. Since the satellite signal repeater such as the CTC does not provide audio and data communication services and simply performs the repeating function, it considers only downlink transmission and transmits a necessary signal through a terrestrial network of the terrestrial system when it requires information for the MBMS.

In addition, when the satellite communication system provides the audio and data communication services through the limited frequency resources, it is difficult to provide the communication service to all terminals existing within the multi service areas through beams having a very large coverage. Thus, the satellite communication system provides the audio and data communication services through beams to the terminals existing in an area which is not covered by the terrestrial network within the service area. Furthermore, the CTC transmits an uplink signal to the satellite 102 to provide the audio and data communication service or the MBMS to the terminals which do not exist within the coverage area defined by the beams, that is, the area which is not covered by the terrestrial network within the service area and does not guarantee the satellite signal.

In the satellite communication system, the terminals existing within the area which is not covered by the terrestrial network receive the communication service from the satellite 102 in the above-described manner. When the terminals enter the coverage of the terrestrial network, they execute a vertical handover between the satellite 102 and the terrestrial network in order to receive the communication service from the terrestrial network having higher transmission efficiency than the satellite 102. In this case, the terminals may transmit/receive signals from both the satellite 102 and the terrestrial network. When the terrestrial network and the satellite 102 transmit/receive signals in different access standards, the terminals transmit/receive signals between the terrestrial network and the satellite 102 by using the OFDMA-based satellite radio interface in the above-described manner in order to reduce overhead.

Furthermore, regarding the satellite 102 in the satellite communication system, a single satellite forms multi-beams in a Multi Input Multi Output (MIMO) scheme using a polarization characteristic of an antenna, or a plurality of satellites form hierarchical multi-beams. Then, signals for providing the communication service are transmitted. Accordingly, data transmission capacity is increased and data reception performance is improved. The satellite communication system acquires a spatial diversity gain with respect to a slow-fading effect of the satellite 102 through a cooperative communication and an Ad-hoc network establishment between the terminals by using the CTC, and efficiently uses the finite frequency resources through the multi-beams, thereby improving the total throughput of the system. The satellite communication system improves the power use efficiency of the satellite 102 by using various types of multi-beam patterns, and adaptively provides the communication service according to the user's requirements. Furthermore, the satellite communication system minimizes interference between adjacent beams in the multi-beams, and improves the frequency reuse efficiency.

Moreover, the satellite communication system efficiently uses the available frequency band based on the OFDMA scheme, that is, sets the frequency reuse factor to 1, and provides the service to the terminals existing within the service area. Also, the satellite communication system provides the service to the terminals existing within the shadow area within the service area through the CTC, for example, the CGC 132 or the networks 106 and 110. At this time, considering a case in which the satellite 102 provides the service to the terminals through the multi-beams in an environment where no CTC exists, and a case in which the CTC and the satellite 102 provide the service to the terminals through the multi-beams in the above frequency reuse factor, the satellite communication system provides the service while minimizing interference between the signals transmitted to the terminals, that is, the signals transmitted from the satellite 102 and the CTC, and maximizing the frequency use efficiency when providing the service to the terminals existing within the service area. As described above, the satellite communication system provides the service through the satellite 102 in the nationwide coverage such as the suburb or the rural area, and provides the service by using the CTC in the area where the data traffic volume is larger than a critical value in the nationwide coverage area due to the satellite 102, or the area where the reception of the signal transmitted from the satellite 102 is poor and it is difficult to provide the service through the terrestrial network due to the indoor environment and buildings.

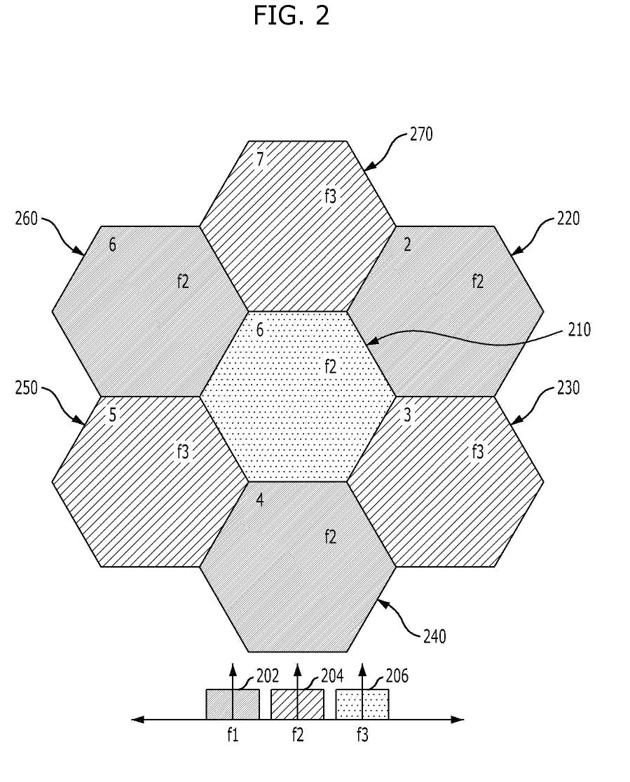

Unlike the case based on the CDMA scheme, the satellite communication system providing the service based on the OFDMA scheme overcomes the difficulty of the frequency use through the partial frequency reuse of the CTC in such a state that the frequency reuse factor is set to 1 as interference occurs between the neighbor cells or the neighbor beam sectors. The satellite communication system divides the service area implemented with one cell into a plurality of beam sectors, and provides the service while maximizing the frequency use efficiency through the multi-beams by using the CTC in the service area divided into the plurality of beam sectors. A multi-beam pattern when the satellite communication system in accordance with the embodiment of the present invention divides the service area into the plurality of beam sectors and provides the service through the multi-beams will be described below in more detail with reference to FIG. 2.

FIG. 2 is a schematic view illustrating a beam pattern of the satellite communication system in accordance with the embodiment of the present invention.

Referring to FIG. 2, in order for providing the communication service based on the multi-beams by using the CTC, the satellite communication system divides a service area into a plurality of beam sectors, for example, a first beam sector 210, a second beam sector 220, a third beam sector 230, a fourth beam sector 240, a fifth beam sector 250, a sixth beam sector 260, and a seventh beam sector 270. The divided beam sectors 210, 220, 230, 240, 250, 260 and 270 correspond to one beam of the multi-beams, respectively, and the satellite communication system divides the service area into the plurality of beam sectors 210, 220, 230, 240, 250, 260 and 270 according to the multi-beams. That is, as the satellite BS of the satellite communication system forms seven multi-beams in order for providing the service, the service area is divided into seven beam sectors 210, 220, 230, 240, 250, 260 and 270 corresponding to the seven multi-beams, and one multi-beam corresponds to one beam sector to provide the service. As described above, the divided beam sectors 210, 220, 230, 240, 250, 260 and 270 become the access slots corresponding to the multi-beams. As described above in the access slots, the divided beams sectors 210, 220, 230, 240, 250, 260 and 270 are a plurality of access slots, which are formed by dividing the service area, as a space area in which the terminals can receive the service in the beam directions according to the array patterns of the multi-beams. When the satellite communication system in accordance with the embodiment of the present invention provides the service to the service area through the multi-beams by using the CTC, the divided beams sectors 210, 220, 230, 240, 250, 260 and 270 are the division unit of the service area which is divided by the multi-beams. That is, the divided beams sectors 210, 220, 230, 240, 250, 260 and 270 refer to the spatial service area where the service is provided through the single beam.

In order to minimize the interference between the adjacent beams providing the service to the adjacent beam sectors when the satellite communication system provides the service to the divided beam sectors 210, 220, 230, 240, 250, 260 and 270 based on the multi-beams, the frequency band available when providing the service to the service area is divided into frequency bands having a plurality of center frequencies, for example, a first frequency band 202 having a center frequency of f1, a second frequency band 204 having a center frequency of f2, and a third frequency band 206 having a center frequency of f3.

Also, the satellite communication system allocates the divided frequency bands 202, 204 and 206 to the divided beam sectors 210, 220, 230, 240, 250, 260 and 270 with respect to the beams included in the multi-beams in order to provide the service to the service area through the multi-beams. At this time, in order to minimize the interference between the adjacent beams of the adjacent beam sectors, the frequency bands having different center frequencies are allocated to the adjacent beam sectors. The first frequency band 202 having the center frequency of f1 is allocated to the first beam sector 210, and the second frequency band 204 having the center frequency f2 is allocated to the second beam sector 220, the fourth beam sector 240, and the sixth beam sector 260. The third frequency band 206 is allocated to the third beam sector 230, the fifth beam sector 250, and the seventh beam sector 270.

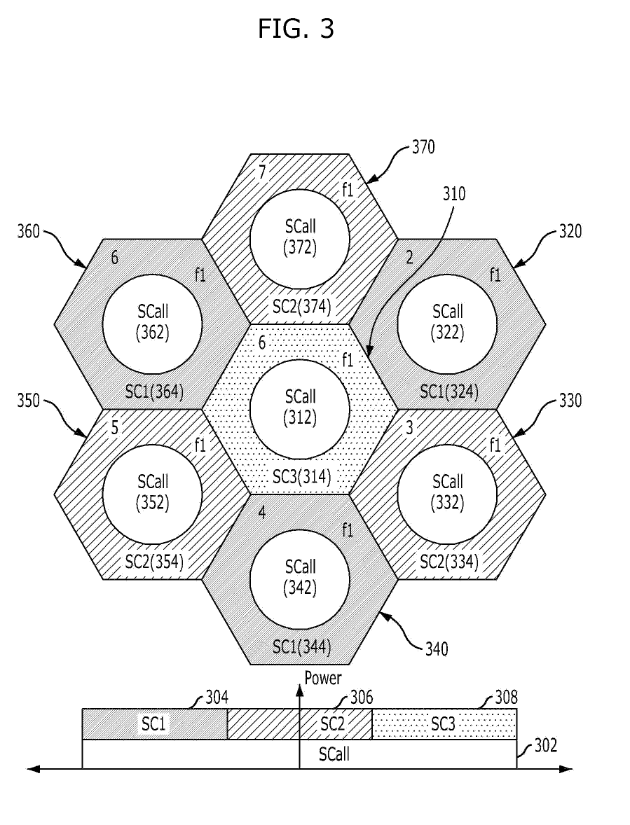

In addition, the satellite communication system provides the service based on the multi-beams through the frequency bands 202, 204 and 206 allocated to the beam sectors 210, 220, 230, 240, 250, 260 and 270 in the above-described manner. Since the satellite communication system provides the service to the service area based on the OFDMA scheme, the service can be provided by dividing the available frequency bands into a plurality of subcarrier groups and allocating the subcarrier groups to the divided beam sectors 210, 220, 230, 240, 250, 260 and 270. Hereinafter, the multi-beam pattern when the satellite communication system in accordance with the embodiment of the present invention provides the service through the multi-beams based on the OFDMA scheme will be described in more detail with reference to FIG. 3.

FIG. 3 is a schematic view illustrating another beam pattern of the satellite communication system in accordance with the embodiment of the present invention.

Referring to FIG. 3, in order for providing the communication service based on the multi-beams by using the CTC, the satellite communication system divides a service area into a plurality of beam sectors, for example, a first beam sector 310, a second beam sector 320, a third beam sector 330, a fourth beam sector 340, a fifth beam sector 350, a sixth beam sector 360, and a seventh beam sector 370. The divided beam sectors 310, 320, 330, 340, 350, 360 and 370 correspond to one beam of the multi-beams, respectively, and the satellite communication system divides the service area into the plurality of beam sectors 310, 320, 330, 340, 350, 360 and 370 according to the multi-beams. That is, as the satellite BS of the satellite communication system forms seven multi-beams in order for providing the service, the service area is divided into seven beam sectors 310, 320, 330, 340, 350, 360 and 370 corresponding to the seven multi-beams, and one multi-beam corresponds to one beam sector to provide the service. As described above, the divided beam sectors 310, 320, 330, 340, 350, 360 and 370 become the access slots corresponding to the multi-beams. As described above in the access slots, the divided beams sectors 310, 320, 330, 340, 350, 360 and 370 are a plurality of access slots, which are formed by dividing the service area, as a space area in which the terminals can receive the service in the beam directions according to the array patterns of the multi-beams. When the satellite communication system in accordance with the embodiment of the present invention provides the service to the service area through the multi-beams by using the CTC, the divided beams sectors 310, 320, 330, 340, 350, 360 and 370 are the division unit of the service area which is divided by the multi-beams. That is, the divided beams sectors 310, 320, 330, 340, 350, 360 and 370 refer to the spatial service area where the service is provided through the single beam.

The satellite communication system divides the divided beams sectors 310, 320, 330, 340, 350, 360 and 370 into beam center areas and beam edge areas. In other words, the satellite communication system divides the first beam sector 310 into a first beam center area 312 and a first beam edge area 314, divides the second beam sector 320 into a second beam center area 322 and a second beam edge area 324, and divides the third beam sector 330 into a third beam center area 332 and a third beam edge area 334. Also, the satellite communication system divides the fourth beam sector 340 into a fourth beam center area 342 and a fourth beam edge area 344, divides the fifth beam sector 350 into a fifth beam center area 352 and a fifth beam edge area 354, divides the sixth beam sector 360 into a sixth beam center area 362 and a sixth beam edge area 364, and divides the seventh beam sector 370 into a seventh beam center area 372 and a seventh beam edge area 374.

In order to minimize the interference between the adjacent beams providing the service to the adjacent beam sectors when the satellite communication system provides the service to the divided beam sectors 310, 320, 330, 340, 350, 360 and 370 based on the multi-beams, the frequency band available when providing the service to the service area is divided into a plurality of subcarrier groups, for example, a first subcarrier group (SC1) 304, a second subcarrier group (SC2) 306, and a third subcarrier group (SC3) 308.

Also, the satellite communication system may allocate a frequency band having a center frequency of f1 to the divided beam sectors 310, 320, 330, 340, 350, 360 and 370 in order to provide the service to the service area through the multi-beams by setting the frequency reuse factor to 1. At this time, in order to minimize the interference between the adjacent beams of the adjacent beam sectors, the satellite communication system allocates all subcarriers (SCall) 302 of the available frequency bands to the center areas 312, 322, 332, 342, 352, 362 and 372 of the beam sectors 310, 320, 330, 340, 350, 360 and 370, and allocates the subcarrier groups 304, 306 and 308, which are defined by dividing the available frequency bands, to the edge areas 314, 324, 334, 344, 354, 364 and 374 of the beam sectors 310, 320, 330, 340, 350, 360 and 370.

As described above, in order to minimize the interference between the adjacent beams of the adjacent beam sectors, the satellite communication system allocates the different subcarrier groups to the edge areas of the adjacent beam sectors among the divided beam sectors 310, 320, 330, 340, 350, 360 and 370. In other words, the satellite communication system allocates the third subcarrier group 308 to the first edge area 314 of the first beam sector 310, allocates the first subcarrier group 304 to the second edge area 324 of the second beam sector 320, the fourth edge area 344 of the fourth beam sector 340, and the sixth edge area 364 of the sixth beam sector 360, and allocates the second subcarrier group 306 to the third edge area of the third beam sector 330, the fifth edge area 354 of the fifth beam sector 350, and the seventh edge area 374 of the seventh beam sector 370.

In addition, the satellite communication system allocates all subcarriers 302 or subcarrier groups 304, 306 and 308 of the available frequency bands in the above-described manner, and provides the service based on the multi-beams.

The satellite communication system uses the frequency bands available in the multi-beams based on the OFDMA scheme by setting the frequency reuse factor to 1, thereby improving the frequency use efficiency. In order to minimize the interference between the adjacent beams, the service is provided to the edge areas 314, 324, 334, 354, 364 and 374 of the beam sectors 310, 320, 330, 340, 350, 360 and 370 through the different subcarrier groups 304, 306 and 308, based on the OFDMA scheme. The service is provided to the center areas 312, 322, 332, 342, 352, 362 and 372 of the beam sectors 310, 320, 330, 340, 350, 360 and 370 through all subcarriers 302 of the available frequency band.

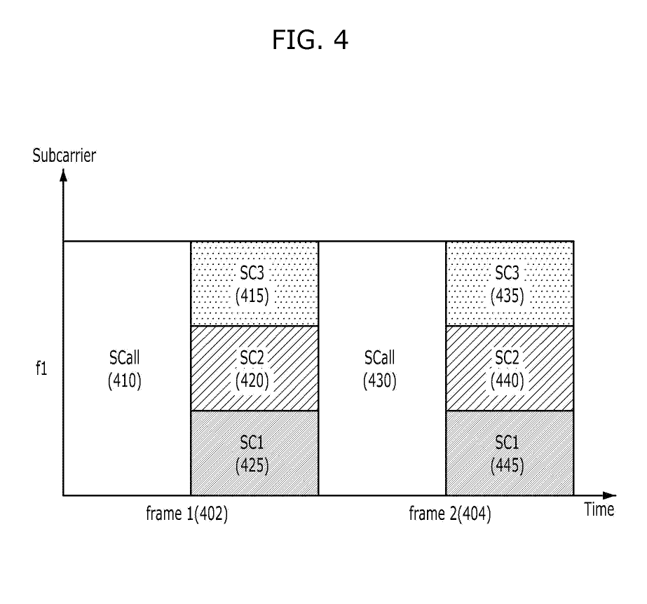

When the satellite communication system simultaneously performs the signal transmission to the terminals existing in the center areas 312, 322, 332, 342, 352, 362 and 372 of the beam sectors 310, 320, 330, 340, 350, 360 and 370 through all subcarriers 302 and the signal transmission to the terminals existing in the edge areas 314, 324, 334, 354, 364 and 374 of the beam sectors 310, 320, 330, 340, 350, 360 and 370 through the subcarrier groups 304, 306 and 308, interference may occur between the signals transmitted through all subcarriers 302 and the signals transmitted through the subcarrier groups 304, 306 and 308. However, when transmitting the signals to the existing in the center areas 312, 322, 332, 342, 352, 362 and 372 and the edge areas 314, 324, 334, 344, 354, 364 and 374 of the beam sectors 310, 320, 330, 340, 350, 360 and 370, the satellite communication system in accordance with the embodiment of the present invention minimizes the interference between the transmitted signals through the time multiplexing within a transmission frame for signal transmission. Furthermore, in order to minimize the interference between the signals transmitted through all subcarriers 302 and the signals transmitted through the subcarrier groups 304, 306 and 308, the satellite communication system minimizes the interference between the transmitted signals by transmitting the signals in such a state that the power level of the signals transmitted through all subcarriers 302 is lower than the power level of the signals through the subcarrier groups 304, 306 and 308. A frame structure when the satellite communication system in accordance with the embodiment of the present invention provides the communication service through the multi-beams will be described in more detail with reference to FIG. 4.

FIG. 4 is a diagram schematically illustrating a frame structure of the satellite communication system in accordance with the embodiment of the present invention. Specifically, FIG. 4 is a diagram schematically illustrating a frame structure when the satellite communication system provides the communication service with the multi-beam pattern in order to reuse the subcarriers of the frequency band based on the OFDMA scheme, as described above with reference to FIG. 3. In FIG. 4, although the description will be focused on the satellite communication system which divides the available frequency band into three subcarrier groups, that is, a first subcarrier group, a second subcarrier group, and a third subcarrier group, and allocates the subcarrier groups to the edge areas of the beam sectors determined by the multi-beams, as described above with reference to FIG. 3, the invention may also be equally applied to other cases of dividing the available frequency band into more than three subcarrier groups.

Referring to FIG. 4, the satellite communication system divides a time period of a predetermined frame, for example, a first frame 402 and a second frame 404, allocates the divided time period to provide the communication service through all subcarriers (SCall) areas 410 and 430 of a first time period in the center areas of the beam sectors, and divides a second time period into a plurality of subcarrier group areas, for example, first subcarrier group (SC1) areas 425 and 445 and second subcarrier group (SC2) areas 420 and 440, and third subcarrier group (SC3) areas 415 and 435, and allocates the subcarrier group areas to provide the communication service through the divided subcarrier group areas 425, 445, 420, 440, 415 and 435 in the edge areas of the beam sectors.

The satellite communication system transmits data traffic to the terminals existing in the center areas of the beam sectors by using the subcarrier areas 410 and 430 of the first time period which is set to the frequency reuse factor of 1, and transmits data traffic to the terminals through the subcarrier group areas 425, 445, 420, 440, 415 and 435 of the second time period by minimizing the interference between the adjacent beams in the edge areas of the beam sectors. Also, when the satellite communication system divides the subcarrier group into more than three or less than three, the satellite communication system divides the second time period into the corresponding subcarrier group area, allocates the subcarrier group area to the edge areas of the beam sectors, and provides the communication service. the size of the subcarrier areas 410 and 430 in the first time period and the size of the subcarrier group areas 425, 445, 420, 440, 415 and 435 in the second time period are determined by the traffic volume in the center areas and the edge areas of the beam sectors, that is, the number of the terminals existing in the respective areas and the traffic volumes of the respective terminals.

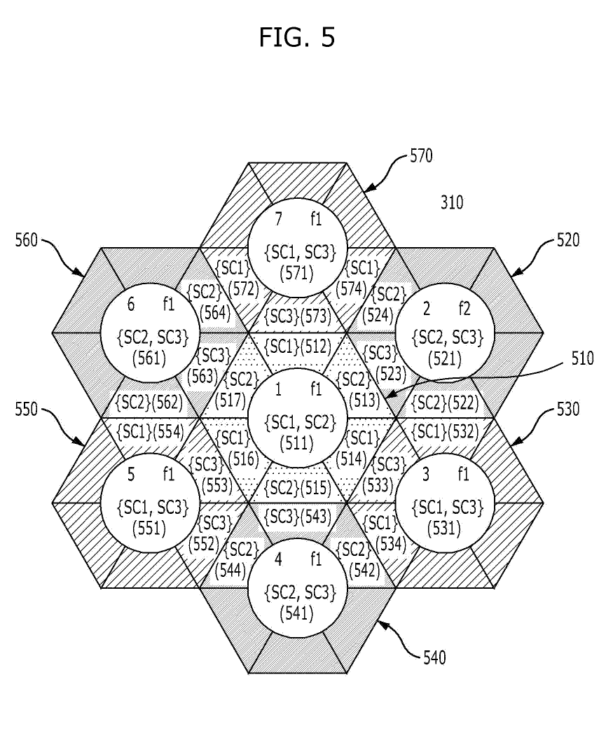

In addition, the satellite communication system divides the service area into a plurality of beam sectors according to the multi-beams, based on the OFDMA scheme, and provides the service through the subcarriers or subcarrier groups of the available frequency band. At this time, as described above, the CTCs existing within the plurality of beam sectors also provide the service through the allocated subcarriers or subcarrier groups of the available frequency band. In the satellite communication system in accordance with the embodiment of the present invention, a multi-beam pattern of the CTC when the CTC provides the service through the multi-beams will be described in more detail with reference to FIG. 5.

FIG. 5 is a diagram schematically illustrating another beam pattern of the satellite communication system in accordance with the embodiment of the present invention. FIG. 5 illustrates a beam pattern of a CTC when the satellite BS of the satellite communication system provides the service through the subcarriers or subcarrier groups of the available frequency band, as described above with reference to FIG. 3. In other words, FIG. 5 illustrates a beam pattern of a CTC in order for minimizing interference between signals transmitted from the CTC and maximizing the frequency use efficiency by reusing the frequencies usable by the satellite communication system, for example, the satellite BS and the CTC, when the satellite BS of the satellite communication system transmits the signal through the beam pattern of FIG. 3.

Referring to FIG. 5, as described above with reference to FIG. 3, in order for providing the communication service based on the multi-beams by using the CTC, the satellite communication system divides a service area into a plurality of beam sectors, for example, a first beam sector 510, a second beam sector 520, a third beam sector 530, a fourth beam sector 540, a fifth beam sector 550, a sixth beam sector 560, and a seventh beam sector 570. As described above, the divided beam sectors 510, 520, 530, 540, 550, 560 and 570 correspond to one beam of the multi-beams, respectively, and the satellite communication system divides the service area into the plurality of beam sectors 510, 520, 530, 540, 550, 560 and 570 according to the multi-beams. That is, as the satellite BS of the satellite communication system forms seven multi-beams in order for providing the service, the service area is divided into seven beam sectors 510, 520, 530, 540, 550, 560 and 570 corresponding to the seven multi-beams, and one multi-beam corresponds to one beam sector to provide the service. As described above, the divided beam sectors 510, 520, 530, 540, 550, 560 and 570 become the access slots corresponding to the multi-beams. As described above in the access slots, the divided beams sectors 510, 520, 530, 540, 550, 560 and 570 are a plurality of access slots, which are formed by dividing the service area, as a space area in which the terminals can receive the service in the beam directions according to the array patterns of the multi-beams. When the satellite communication system in accordance with the embodiment of the present invention provides the service to the service area through the multi-beams by using the CTC, the divided beams sectors 510, 520, 530, 540, 550, 560 and 570 are the division unit of the service area which is divided by the multi-beams. That is, the divided beams sectors 510, 520, 530, 540, 550, 560 and 570 refer to the spatial service area where the service is provided through the single beam.

The satellite communication system divides the divided beams sectors 510, 520, 530, 540, 550, 560 and 570 into beam center areas and beam edge areas in order to minimize the interference between the signals transmitted from the satellite BS and the CTC and improve the frequency use efficiency through the frequency reuse when the satellite BS and the CTC transmit the signals. When providing the service by using the CTC, the satellite communication system divides the edge areas of the beam sectors 510, 520, 530, 540, 550, 560 and 570 into a plurality of edge areas in each beam sector in order to minimize the interference between the signals transmitted from the satellite BS, which provides the service through the beam pattern of FIG. 3, and the signals transmitted from the CTCs existing within the divided beam sectors 510, 520, 530, 540, 550, 560 and 570. Predetermined subcarrier groups are allocated to the edge areas of the divided beam sectors 510, 520, 530, 540, 550, 560 and 570 through the frequency reuse. For example, subcarrier groups used by the satellite BS are allocated so that they are reused in the beam sectors 510, 520, 530, 540, 550, 560 and 570.

In other words, the satellite communication system divides the first beam sector 510 into a first beam center area 511 and first beam edge areas 512, 513, 514, 515, 516 and 517, divides the second beam sector 520 into a second beam center area 521 and second beam edge areas 522, 523 and 524, and divides the third beam sector 530 into a third beam center area 531 and third beam edge areas 532, 533 and 534. Also, the satellite communication system divides the fourth beam sector 540 into a fourth beam center area 541 and fourth beam edge areas 542, 543 and 544, divides the fifth beam sector 550 into a fifth beam center area 551 and fifth beam edge areas 552, 553 and 554, divides the sixth beam sector 560 into a sixth beam center area 561 and sixth beam edge areas 562, 563 and 564, and divides the seventh beam sector 570 into a seventh beam center area 571 and seventh beam edge areas 572, 573 and 574.

In order to minimize the interference between the adjacent beams providing the service to the adjacent beam sectors and reuse the frequencies when the satellite communication system provides the service to the divided beam sectors 510, 520, 530, 540, 550, 560 and 570 based on the multi-beams, the frequency band available when providing the service to the service area is divided into a plurality of subcarrier groups, for example, a first subcarrier group (SC1), a second subcarrier group (SC2), and a third subcarrier group (SC3) as described above with reference to FIG. 3.

Also, the satellite communication system may allocate a frequency band having a center frequency of f1 to the divided beam sectors 510, 520, 530, 540, 550, 560 and 570 in order to provide the service to the service area through the multi-beams by setting the frequency reuse factor to 1. At this time, in order to minimize the interference between the adjacent beams of the adjacent beam sectors when the satellite BS provides the service through the multi-beams, the satellite communication system allocates all subcarriers (SCall) of the frequency bands, which are usable in the multi-beams of the satellite BS, to the center areas 511, 521, 531, 541, 551, 561 and 571 of the beam sectors 510, 520, 530, 540, 550, 560 and 570, allocates the first subcarrier group (SC1) to all edge areas of the second beam sector 520, the fourth beam sector 540, and the sixth beam sector 560, and allocates the second subcarrier group (SC2) to all edge areas of the third beam sector 530, the fifth beam sector 550, and the seventh beam sector 570.

In order to minimize the interference between the signals transmitted from the satellite BS and the signals transmitted from the CTC and maximize the frequency use efficiency through the frequency reuse, the satellite communication system allocates the subcarrier groups of the frequency band available in the multi-beams of the CTC to the center areas 511, 521, 531, 541, 551, 561 and 571 of the beam sectors 510, 520, 530, 540, 550, 560 and 570 and the plurality of edge areas of each beam sector according to the beam pattern of the satellite BS determined as described above.

More specifically, in the first beam sector 510, the third subcarrier group (SC3) is allocated to the edge area of the first beam sector 510 and the satellite BS provides the service. Thus, the first subcarrier group (SC1) or the second subcarrier group (SC2) is allocated to the center area 511 of the first beam sector 510 through the frequency reuse and the CTC provides the service. The subcarrier group different from the edge areas of the adjacent sector beams, that is, the first subcarrier group (SC1) is allocated to the first edge areas 512, 514 and 516 of the first beam sector 510 through the frequency reuse to provide the service, and the second subcarrier group (SC2) is allocated to the first edge areas 513, 515 and 517 of the first beam sector 510 through the frequency reuse to provide the service.

Also, in the second beam sector 520, the first subcarrier group (SC1) is allocated to the edge area of the second beam sector 520 and the satellite BS provides the service. Thus, the second subcarrier group (SC2) or the third subcarrier group (SC3) is allocated to the center area 521 of the second beam sector 520 through the frequency reuse and the CTC provides the service. The subcarrier group different from the edge areas of the adjacent sector beams, that is, the second subcarrier group (SC2) is allocated to the second edge areas 522 and 524 of the second beam sector 520 through the frequency reuse to provide the service, and the third subcarrier group (SC3) is allocated to the second edge area 523 of the second beam sector 520 through the frequency reuse to provide the service.

In the third beam sector 530, the second subcarrier group (SC2) is allocated to the edge area of the third beam sector 530 and the satellite BS provides the service. Thus, the first subcarrier group (SC1) or the third subcarrier group (SC3) is allocated to the center area 531 of the third beam sector 530 through the frequency reuse and the CTC provides the service. The subcarrier group different from the edge areas of the adjacent sector beams, that is, the first subcarrier group (SC1) is allocated to the third edge areas 532 and 534 of the third beam sector 530 through the frequency reuse to provide the service, and the third subcarrier group (SC3) is allocated to the third edge area 533 of the third beam sector 530 through the frequency reuse to provide the service.

In the fourth beam sector 540, the first subcarrier group (SC1) is allocated to the edge area of the fourth beam sector 540 and the satellite BS provides the service. Thus, the second subcarrier group (SC2) or the third subcarrier group (SC3) is allocated to the center area 541 of the fourth beam sector 540 through the frequency reuse and the CTC provides the service. The subcarrier group different from the edge areas of the adjacent sector beams, that is, the second subcarrier group (SC2) is allocated to the fourth edge areas 542 and 544 of the fourth beam sector 540 through the frequency reuse to provide the service, and the third subcarrier group (SC3) is allocated to the fourth edge area 543 of the fourth beam sector 540 through the frequency reuse to provide the service.

In the fifth beam sector 550, the second subcarrier group (SC2) is allocated to the edge area of the fifth beam sector 550 and the satellite BS provides the service. Thus, the first subcarrier group (SC1) or the third subcarrier group (SC3) is allocated to the center area 551 of the fifth beam sector 550 through the frequency reuse and the CTC provides the service. The subcarrier group different from the edge areas of the adjacent sector beams, that is, the first subcarrier group (SC1) is allocated to the fifth edge area 554 of the fifth beam sector 550 through the frequency reuse to provide the service, and the third subcarrier group (SC3) is allocated to the fifth edge areas 552 and 553 of the fifth beam sector 550 through the frequency reuse to provide the service.

In the sixth beam sector 560, the first subcarrier group (SC1) is allocated to the edge area of the sixth beam sector 560 and the satellite BS provides the service. Thus, the second subcarrier group (SC2) or the third subcarrier group (SC3) is allocated to the center area 561 of the sixth beam sector 560 through the frequency reuse and the CTC provides the service. The subcarrier group different from the edge areas of the adjacent sector beams, that is, the second subcarrier group (SC2) is allocated to the sixth edge areas 562 and 564 of the sixth beam sector 560 through the frequency reuse to provide the service, and the third subcarrier group (SC3) is allocated to the sixth edge area 563 of the sixth beam sector 560 through the frequency reuse to provide the service.

In the seventh beam sector 570, the second subcarrier group (SC2) is allocated to the edge area of the seventh beam sector 570 and the satellite BS provides the service. Thus, the first subcarrier group (SC1) or the third subcarrier group (SC3) is allocated to the center area 571 of the seventh beam sector 570 through the frequency reuse and the CTC provides the service. The subcarrier group different from the edge areas of the adjacent sector beams, that is, the first subcarrier group (SC1) is allocated to the seventh edge areas 572 and 574 of the seventh beam sector 570 through the frequency reuse to provide the service, and the third subcarrier group (SC3) is allocated to the seventh edge area 573 of the seventh beam sector 570 through the frequency reuse to provide the service.

The satellite communication system uses the frequency band available in the multi-beams based on the OFDMA scheme in such a state that the frequency reuse factor is set to 1, thereby improving the frequency use efficiency. In order to minimize the interference between the adjacent beams when the satellite BS provides the service, the service is provided through the different subcarrier groups SC1, SC2 and SC3 in the edge areas of the beam sectors 510, 520, 530, 540, 550, 560 and 570 according to the OFDMA scheme, and the service is provided through all subcarriers of the available frequency band in the center areas 511, 521, 531, 541, 551, 561 and 571 of the beam sectors 510, 520, 530, 540, 550, 560 and 570.

Also, in order to minimize the interference between the signals transmitted by the satellite BS and the signals transmitted by the CTC and maximize the frequency use efficiency through the frequency reuse when providing the service by using the CTC, the CTC provides the service through the frequency reuse of the subcarrier groups unused in the edges of the beam sectors by the satellite BS in the center areas 511, 521, 531, 541, 551, 561 and 571 and the edge areas of the beam sectors 510, 520, 530, 540, 550, 560 and 570. At this time, in the edge areas of the adjacent beam sectors, the service is provided through the frequency reuse of the different subcarrier groups. That is, the CTC provides the service through the frequency reuse of the subcarrier group different from the subcarrier group allocated to the edge area of the predetermined beam sector for the satellite BS. At this time, in the edge area of the predetermined beam sector, the service is provided through the frequency reuse of the subcarrier group different from the subcarrier group allocated to the edge area of the adjacent beam sector in the different subcarrier groups.

When providing the service to the service area through the multi-beams, the satellite communication system divides the service area into the plurality of beam sectors according to the multi-beams, and the CTC existing within the corresponding beam sector reuses the subcarrier group unused in the divided multi-beams by the satellite BS, that is, the subcarrier group unused in the edge area of the beam sector by the satellite BS while considering the interference between the adjacent beams. Thus, the service is provided by setting the frequency reuse factor to 1. That is, the frequency use efficiency is maximized through the frequency reuse. Also, the interference between the adjacent beams and the interference between the transmitted signals are minimized through the frequency reuse of those subcarrier groups.

As described above, in order to provide the service based on the multi-beams at the same with the satellite BS, the CTC of the satellite communication system performs the communication through the beam division multiple access scheme within the beam sectors defined by dividing the service area according to the multi-beams. When the satellite BS provides the service to the center areas and the edge areas of the beam sectors by using the subcarriers or subcarrier groups of the available frequency band through the multi-beams in a predetermined time period, the CTC monitors the transmitted signals between the terminal and the satellite BS within the beam sectors when the satellite BS provides the service.

The CTC confirms the subcarrier or subcarrier group used by the satellite BS in the corresponding beam sector by the monitoring, and confirms the subcarrier group usable by the CTC. At this time, the satellite BS transmits information about the subcarrier or subcarrier group used by the satellite BS through a header of a frame or a control channel. The CTC confirms the information transmitted through the header of the frame or the control frame through the above-described monitoring, and confirms the subcarrier group usable by the CTC.

The CTC confirms the information about the subcarrier group usable by the CTC in the center area and the edge area of the beam sector, and provides the service through the communication with the terminal existing within the beam sector through the frequency reuse of the confirmed subcarrier group. The communication with the terminal existing within the beam sector through the subcarrier or subcarrier group usable by the satellite BS, and the communication with the terminal existing within the beam sector through the frequency reuse of the subcarrier group usable by the CTC are performed through the different subcarrier groups. That is, the interference between the transmission signal of the satellite BS and the transmission signal of the CTC based on the multi-beams within the beam sector is minimized. Also, as the interference between the transmission signal of the satellite BS and the transmission signal of the CTC is minimized, the CTC can communicate with the terminal through the subcarrier group usable by the CTC, without considering the position of the terminal within the beam sector.

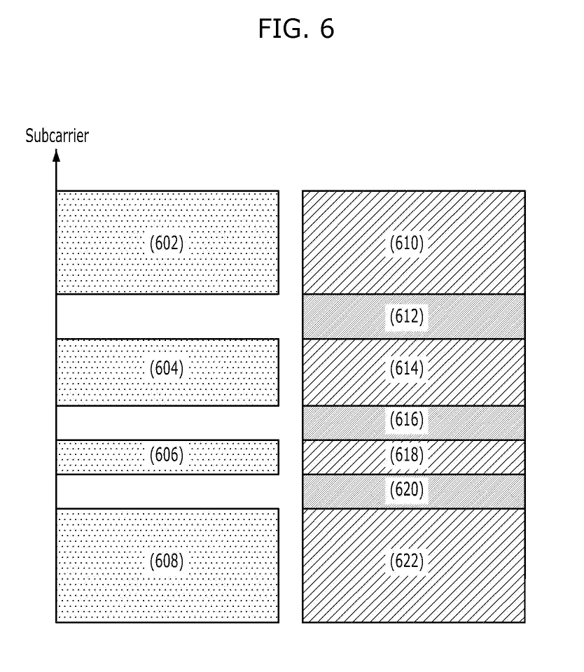

In addition, the CTC confirms the subcarrier or subcarrier group used by the satellite BS in the corresponding beam sector by the monitoring, and confirms the subcarrier group usable by the CTC. As the confirmation result, when the subcarrier group usable by the CTC does not exist, the communication is performed with the terminal, which does not communicate with the satellite BS, through the frequency reuse of the subcarrier group used by the satellite BS. That is, the terminal which is poor in the reception of the signal transmitted through the subcarrier or subcarrier group used by the satellite BS in the beam sector receives the transmission signal for providing the service from the CTC through the frequency reuse of the subcarrier group used by the satellite BS. A frame structure when the satellite BS and the CTC of the satellite communication system in accordance with the embodiment of the present invention provides the communication service through the multi-beams will be described in more detail with reference to FIG. 6.

FIG. 6 is a diagram schematically illustrating another frame structure of the satellite communication system in accordance with the embodiment of the present invention. Specifically, FIG. 6 is a diagram schematically illustrating a frame structure when the satellite BS and the CTC of the satellite communication system provides the communication service through the multi-beams in order for the subcarrier reuse of the frequency band based on the OFDMA scheme.

Referring to FIG. 6, the satellite communication system divides a subcarrier existing in a predetermined available frequency band into a plurality of first subcarrier group areas 602, 604, 606 and 608 to be used when providing the service of the satellite BS. The satellite communication system divides the subcarrier existing in the predetermined available frequency band into a plurality of second subcarrier group areas 610, 614, 618 and 622 as the plurality of subcarrier groups to be used when providing the service of the CTC, in the same frequency band intervals as the first subcarrier group areas 602, 604, 606 and 608. Also, the satellite communication system divides the remaining subcarriers of the frequency band, except for the second subcarrier group areas 610, 614, 618 and 622, into a plurality of third subcarrier group areas 612, 616 and 620.

The first subcarrier group areas 602, 604, 606 and 608 are spaced apart from one another by a predetermined interval in the available frequency band, and the second subcarrier group areas 610, 614, 618 and 622 are spaced apart from one another by a predetermined interval in the same frequency band as the first subcarrier group areas 602, 604, 606 and 608. That is, the first subcarrier group areas 602, 604, 606 and 608 and the second subcarrier group areas 610, 614, 618 and 622 are the subcarrier groups of the same frequency band and reuse the subcarrier groups. Accordingly, the frequency use efficiency is maximized through the subcarrier reuse of the limited frequencies. The third subcarrier group areas 612, 616 and 620 are allocated to the frequency band corresponding to the predetermined interval in the frequency band in which the second subcarrier group areas 610, 614, 618 and 622 are spaced apart, that is, the predetermined available frequency band.

The satellite communication system divides the subcarriers existing in the predetermined available frequency band into the plurality of subcarrier group areas, and performs the communication between the satellite BS and the terminal based on the multi-beams though the first subcarrier group areas 602, 604, 606 and 608, that is, provides the service from the satellite BS to the terminal within the beam sector through the first subcarrier group areas 602, 604, 606 and 608. Also, the satellite communication system allows the communication between the terminal and the CTC existing within the beam sector where the communication between the satellite BS and the terminal is performed through the second subcarrier group areas 610, 614, 618 and 622, for example, the terminal and the CTC existing within the center area of the beam sector. That is, the satellite communication system allows the CTC to provide the service to the terminal existing in the center area of the beam sector through the second subcarrier group areas 610, 614, 618 and 622. In addition, the satellite communication system allows the communication between the terminal and the CTC existing within the beam sector where the communication between the satellite BS and the terminal is not performed through the third subcarrier group areas 612, 616 and 620, for example, the terminal and the CTC existing within the edge area of the beam sector. That is, the satellite communication system allows the CTC to provide the service to the terminal existing in the edge area of the beam sector through the third subcarrier group areas 612, 616 and 620.

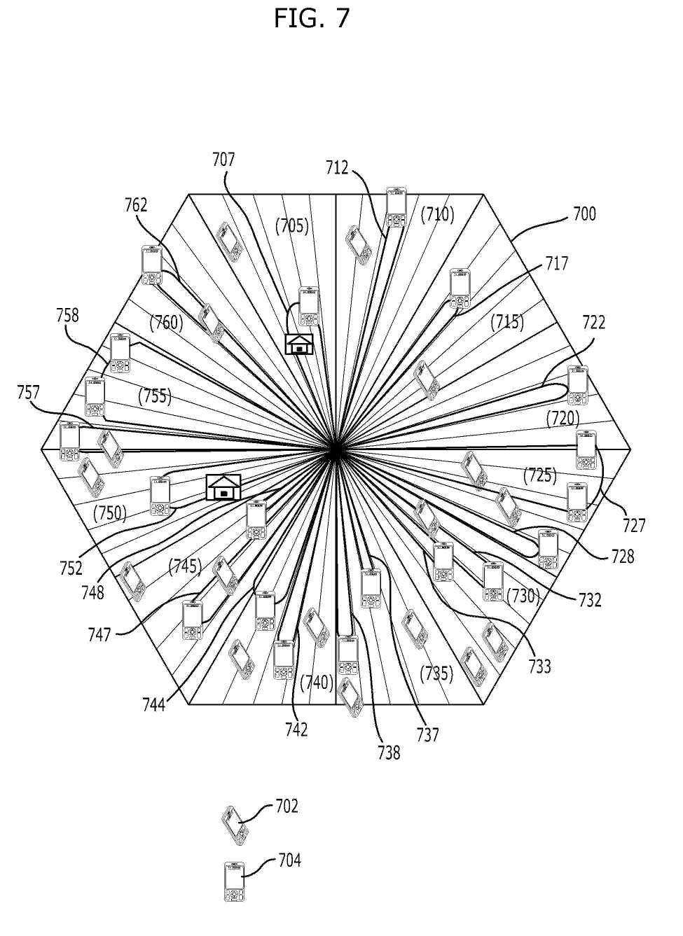

The satellite communication system divides the subcarriers of the predetermined frame into the plurality of subcarrier groups, and the satellite BS and the CTC provide the service to the terminals existing within the beam sector through the divided subcarrier groups, based on the multi-beams, thereby minimizing the interference between the signals between the adjacent beams and the interference between the transmission signals. Also, by maximizing the frequency use efficiency through the frequency use efficiency through the frequency reuse, that is, the reuse of the subcarrier groups, and the service is stably provided to the terminals existing within the beam sectors of the service area. The size of the subcarrier group areas divided from the subcarriers of the predetermined frame is determined by the traffic volume in the center areas and the edge areas of the beam sectors, that is, the number of the terminals existing in each area and the traffic volume of each terminal. In the satellite communication system in accordance with the embodiment of the present invention, a beam pattern of the multi-beams formed by an array antenna of the satellite communication system in correspondence to the terminals existing within the service area will be described in more detail with reference to FIG. 7.

FIG. 7 is a diagram schematically illustrating another beam pattern of the satellite communication system in accordance with the embodiment of the present invention. Specifically, FIG. 7 is a diagram schematically illustrating a beam pattern of the multi-beams formed within the service area through the array antenna by the satellite BS and the CTC of the satellite communication system.

Referring to FIG. 7, when providing a service to a service area 700 based on multi-beams, the satellite communication system divides the service area 700 into a plurality of beam sectors 705, 710, 715, 720, 725, 730, 735, 740, 745, 750, 755 and 760 according to the multi-beams formed in the service area 700 by the array antenna. A plurality of terminals, for example, a first terminal 702 receiving the service from the satellite BS by performing a communication with the satellite BS, and a second terminal 704 receiving the service from the CTC by performing a communication with the CTC, are provided in the divided beam sectors 705, 710, 715, 720, 725, 730, 735, 740, 745, 750, 755 and 760.

In order to minimize the interference between the adjacent beams based on the multi-beams and maximize the frequency use efficiency through the frequency reuse, that is, the reuse of the subcarrier groups, the satellite BS provides the service to the first terminal 702 through all subcarriers or a predetermined subcarrier group. In order to minimize the interference with the transmission signal of the satellite BS based on the multi-beams and maximize the frequency use efficiency through the frequency reuse, for example, the reuse of the subcarrier group, the CTC provides the service to the second terminal 704 through the predetermined subcarrier group. The second terminal 704 receives the service from the CTC through the multi-beams 707, 712, 717, 722, 727, 728, 732, 733, 737, 738, 742, 744, 747, 748, 752, 757, 758 and 762.

More specifically, the satellite communication system divides the service area 700 into a plurality of access slots, that is, the beam sectors 705, 710, 715, 720, 725, 730, 735, 740, 745, 750, 755 and 760 according to the multi-beams formed by the array antenna of the satellite BS. At this time, in order to minimize the interference between the adjacent beams formed when the terminals existing in the access slots are adjacent and form the beams for the terminals, the coverage size of the access slots formed in the respective terminals is increased. That is, the beam size is increased so that the service area is divided into the access slots to completely cover the terminals. That is, in order to minimize the interference between the adjacent beams, the satellite communication system adjusts the coverage size of the multi-beams, considering the positions of the terminals existing within the service area 700, or the distribution and traffic volume of the terminals. Accordingly, the size of the beam sectors defined by dividing the service area 700 is adjusted.

Also, when a GPS is provided in the terminals existing in the beam sectors of the service area 700, the CTC acquires the position information of the second terminal 704 within the beam sectors through the GPS, or acquires the position information of the second terminal 704 through the channel information of the second terminal 704 when the second terminal 704 attempts to communicate with the CTC. At this time, the CTC acquires the moving speed information of the second terminal 704. In addition, the satellite BS acquires the position information of the first terminal 702, and the CTC receives and acquires the position information of the first terminal 702 from the satellite BS. When no GPS is provided in the terminals, the CTC confirms the position and speed of the second terminal 704 through the beam monitoring using its own multi-beams, and acquires the position information and the moving speed information of the second terminal 704. Furthermore, the CTC acquires the channel information of the first terminal 702 from the satellite BS, and acquires the position information and the moving speed information of the first terminal 702 by using the acquired channel information of the first terminal 702.

The CTC having acquired the position information and the moving speed information of the first terminal 702 and the second terminal 704 confirms the first terminal 702 and the second terminal 704 existing in each beam sector within the beams sectors, that is, the access slots set according to the multi-beams of the satellite BS. Then, in order to maximize the frequency use efficiency through the frequency reuse and minimize the interference between the adjacent beams, the satellite BS of the satellite communication system provides the service to the first terminal 702 existing within each beam sector through the single beam for each beam sector in the first subcarrier group areas 602, 604, 606 and 608 described above with reference to FIG. 6. Furthermore, in order to maximize the frequency use efficiency through the frequency reuse and minimize the interference between the adjacent beams, the CTC provides the service to the second terminal 704 existing within each beam sector through the multi-beams in the second subcarrier group areas 610, 614, 618 and 622 and the third subcarrier group areas 612, 616 and 620 described above with reference to FIG. 6.

The CTC confirms the channel state of the second terminal 704 according to the position information and the moving speed information of the second terminal 704, and determines the coverage size of the beam providing the service to the second terminal 704 according to the confirmed channel state of the second terminal 704. For example, when the channel state of the second terminal 704 is poor due to obstacles such as buildings, the coverage size of the multi-beams 707 and 752 is formed to be large so that the second terminal 704 receives the service from the CTC. When the second terminal 704 is moving at a high speed, the coverage size of the multi-beams 727 and 758 is formed to be large so that the second terminal 704 receives the service from the CTC. When a plurality of second terminals 704 exist closely within the beam sectors, the coverage size of the multi-beams 733, 737, 742 and 748 is formed to be small so that the second terminals 704 receive the service from the CTC. That is, the coverage size of the multi-beams is determined according to the positions and moving speeds of the second terminals 704.

Also, according to the position of the first terminal 702, for example, when the first terminal 702 exists within the multi-beams 727, 732, 738, 744, 747, 757 and 762 of the CTC, that is, when the second terminal 704 receives the signal transmitted from the satellite BS, the second terminal 704 receives the service from the CTC through the multi-beams 727, 732, 738, 744, 747, 757 and 762 in the third subcarrier group areas 612, 616 and 620 in order to minimize the interference between the signal transmitted to the first terminal 702 and the signal transmitted to the second terminal 704. When the first terminal 702 does not exist within the multi-beams 707, 712, 717, 722, 728, 733, 737, 742, 748, 752 and 758 of the CTC, that is, when the second terminal 704 does not receive the signal transmitted from the satellite BS, no interference occurs between the signals transmitted from the satellite BS and the CTC. Thus, the second terminal 704 receives the service from the CTC through the multi-beams 707, 712, 717, 722, 728, 733, 737, 742, 748, 752 and 758 in the second subcarrier group areas 610, 614, 618 and 622 of FIG. 6.

More specifically, when the first terminal 702 exists in the access slot where the second terminal 704 performing the communication through the multi-beams of the CTC exists, that is, when the second terminal 704 performs the communication through the multi-beams 727, 732, 738, 744, 747, 757 and 762, the second terminal 704 receives the signal from the CTC through the third subcarrier group areas 612, 616 and 620 of FIG. 6 in the above-described manner, thereby minimizing the interference between the signals transmitted from the satellite BS. Accordingly, the CTC confirms the traffic requirements of the second terminal 704 in each beam sector, that is, the service type intended to be received, and the position, speed or channel information, determines the priority according to the required QoS or the channel states of the terminals, and selects an optimum terminal. The CTC allocates the access slots to each beam sector according to the channel state of the selected terminal, that is, determines the coverage size such as the beam angles of the multi-beams. At this time, the total power of each beam radiated in each beam sector is lower than the usable maximum power of the CTC, and the satellite communication system determines the powers and angles of the multi-beams, that is, the power, the coverage size and the beam directions of the multi-beams, in order to maximize the capacity of all beam access which performs the beam division multiple access with the terminals existing in each beam sector.

For example, the CTC confirms the channel state of the second terminal 704 existing within the beam sector according to the position and the moving speed of the second terminal 704, and determines the size of the beam according to the confirmed channel state of the second terminal 704. In other words, when the channel state of the second terminal 704 is poor due to obstacles such as buildings or the second terminal 704 is moving at a high speed, the CTC forms the coverage size of the multi-beams 707, 727, 752 and 758 is formed to be large so that the second terminal 704 receives the service from the CTC. That is, the CTC determines the optimized coverage size and power of the multi-beams to be formed for performing the communication of the second terminal 704, considering the position and the moving speed of the second terminal 704, which determine the channel state of the second terminal 704.

The CTC determines the coverage size and power of the multi-beams, considering a total number of the second terminals 704 existing within the service area 700 or the beam sector, a maximum power usable when the CTC transmits the signal through the multi-beams, an antenna gain when the signal is transmitted to the second terminal 704 through the multi-beams, a channel state between the multi-beams of the CTC and the second terminal 704, and a channel state between the multi-beams of the satellite BS and the second terminal 704, an antenna state, and a transmission power. That is, the total power of each beam radiated to each beam sector is lower than the maximum usable power of the CTC, and the power and angle of the multi-beams, that is, the power, the coverage size and the beam directions of the multi-beams, are determined to maximize the capacity of all beam accesses in which the terminals existing at each beam sector performs a beam division multiple access.

When the first terminal 702 does not exist in the access slot where the second terminal 704 performing the communication through the multi-beams of the CTC exists, that is, when the second terminal 704 performs the communication through the multi-beams 707, 712, 717, 722, 728, 733, 737, 742, 748, 752 and 758, the second terminal 704 receives the signal from the CTC through the second subcarrier group areas 610, 614, 618 and 622 of FIG. 6 in the above-described manner, thereby preventing the occurrence of the interference between the signals transmitted by the satellite BS. Accordingly, the CTC confirms the traffic requirements of the second terminal 704 in each beam sector, that is, the service type to be received, and the position, speed or channel information, determines the priority according to the required QoS or the channel states of the terminals, and selects an optimum terminal. The CTC allocates the access slots to each beam sector according to the channel state of the selected terminal, that is, determines the coverage size such as the beam angles of the multi-beams. At this time, the total power of each beam radiated in each beam sector is lower than the usable maximum power of the CTC, and the satellite communication system determines the powers and angles of the multi-beams, that is, the power, the coverage size and the beam directions of the multi-beams, in order to maximize the capacity of all beam access which performs the beam division multiple access with the terminals existing in each beam sector.

For example, the CTC confirms the channel state of the second terminal 704 existing within the beam sector according to the position and the moving speed of the second terminal 704, and determines the size of the beam according to the confirmed channel state of the second terminal 704. In other words, when the channel state of the second terminal 704 is poor due to obstacles such as buildings or the second terminal 704 is moving at a high speed, the CTC forms the coverage size of the multi-beams 707, 727, 752 and 758 is formed to be large so that the second terminal 704 receives the service from the CTC. That is, the CTC determines the optimized coverage size and power of the multi-beams to be formed for performing the communication of the second terminal 704, considering the position and the moving speed of the second terminal 704, which determine the channel state of the second terminal 704.

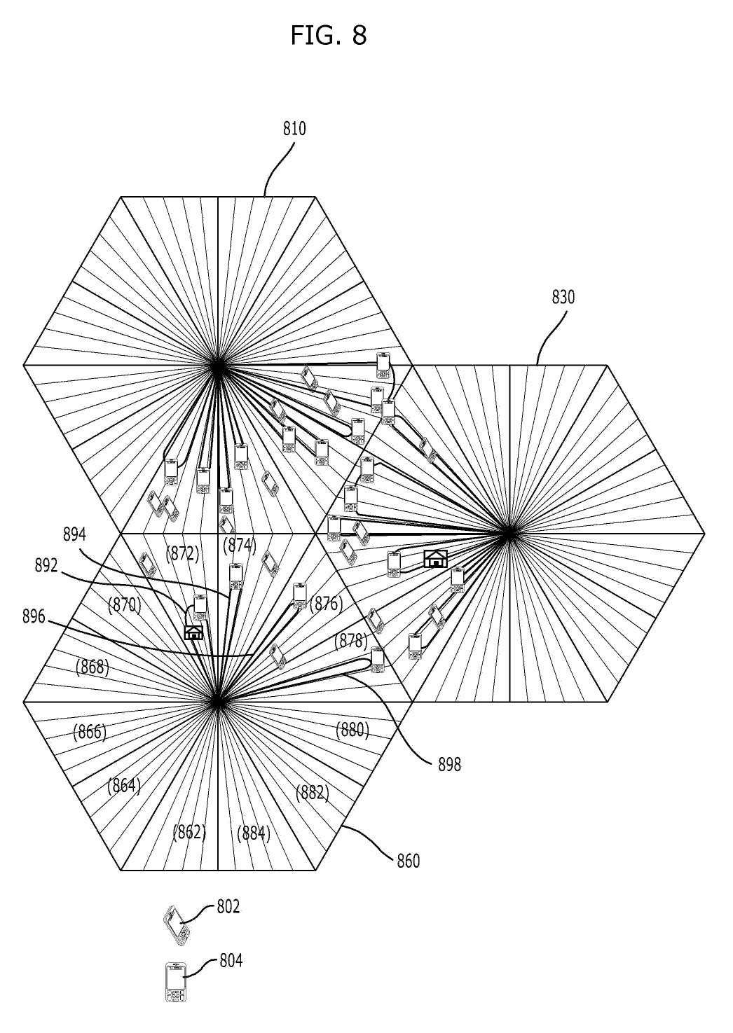

The CTC determines the coverage size and power of the multi-beams, considering a total number of the second terminals 704 existing within the service area 700 or the beam sector, a maximum power usable when the CTC transmits the signal through the multi-beams, an antenna gain when the signal is transmitted to the second terminal 704 through the multi-beams, a channel state between the multi-beams of the CTC and the second terminal 704, and a channel state between the multi-beams of the satellite BS and the second terminal 704, an antenna state, and a transmission power. That is, the total power of each beam radiated to each beam sector is lower than the maximum usable power of the CTC, and the power and angle of the multi-beams, that is, the power, the coverage size and the beam directions of the multi-beams, are determined to maximize the capacity of all beam accesses in which the terminals existing at each beam sector performs a beam division multiple access. In the satellite communication system in accordance with the embodiment of the present invention, a beam pattern of the multi-beams formed by an array antenna of the satellite communication system in correspondence to the terminals existing within the service area will be described in more detail with reference to FIG. 8.

FIG. 8 is a diagram schematically illustrating another beam pattern of the satellite communication system in accordance with the embodiment of the present invention. Specifically, FIG. 8 is a diagram schematically illustrating a beam pattern of the multi-beams formed within the service area through the array antenna by the satellite BS and the CTC of the satellite communication system.

Referring to FIG. 8, when providing a service to a plurality of service areas 810, 830 and 860 based on multi-beams, the satellite communication system divides the service areas 810, 830 and 860 into a plurality of beam sectors according to the multi-beams formed by the array antenna. For example, the satellite communication system divides the third service area 860 into a plurality of beam sectors 862, 864, 866, 868, 870, 872, 874, 876, 878, 880, 882 and 884. A plurality of terminals receiving the service from the satellite communication system exist within the service areas 810, 830 and 860. The plurality of terminals include a plurality of first terminals 802 receiving the service from the satellite BS by performing a communication with the satellite BS of the satellite communication system, and a plurality of second terminals 804 receiving the service from the CTC by performing a communication with the CTC existing within the service areas 810, 830 and 860.

In order to minimize the interference between the adjacent beams based on the multi-beams and maximize the frequency use efficiency, the satellite BS provides the service to the first terminals 802 through subcarriers or a subcarrier group. In order to minimize the interference with the transmission signal of the satellite BS based on the multi-beams and maximize the frequency use efficiency, the CTC provides the service to the second terminals 804 through the subcarrier group. The second terminals 804 receive the service from the CTC through the multi-beams 892, 894, 896 and 898.

More specifically, the satellite communication system divides the service areas 810, 830 and 860 into a plurality of access slots, that is, the beam sectors, according to the multi-beams formed in the service areas 810, 830 and 860 by the array antenna of the satellite BS. At this time, in order to minimize the interference between the adjacent beams formed when the terminals existing in the access slots are adjacent and form the beams for the terminals, the coverage size of the access slots formed in the respective terminals is increased. That is, the beam size is increased so that the service area is divided into the access slots to completely cover the terminals. That is, in order to minimize the interference between the adjacent beams, the satellite communication system adjusts the coverage size of the multi-beams, considering the positions of the terminals existing within the service areas 810, 830 and 860, or the distribution and traffic volume of the terminals. Accordingly, the size of the beam sectors defined by dividing the service areas 810, 830 and 860 is adjusted.

Also, when a GPS is provided in the terminals existing in the beam sectors of the service areas 810, 830 and 860, the CTC acquires the position information of the second terminal 804 within the beam sectors through the GPS, or acquires the position information of the second terminal 804 through the channel information of the second terminal 804 when the second terminal 804 attempts to communicate with the CTC. At this time, the CTC acquires the moving speed information of the second terminal 804. In addition, the satellite BS acquires the position information of the first terminal 802, and the CTC receives and acquires the position information of the first terminal 802 from the satellite BS. When no GPS is provided in the terminals, the CTC confirms the position and speed of the second terminal 804 through the beam monitoring using its own multi-beams, and acquires the position information and the moving speed information of the second terminal 804. Furthermore, the CTC acquires the channel information of the first terminal 802 from the satellite BS, and acquires the position information and the moving speed information of the first terminal 802 by using the acquired channel information of the first terminal 802.

The CTC having acquired the position information and the moving speed information of the first terminal 802 and the second terminal 804 confirms the first terminal 802 and the second terminal 804 existing in each beam sector within the beams sectors, that is, the access slots set according to the multi-beams of the satellite BS. Then, in order to maximize the frequency use efficiency through the frequency reuse and minimize the interference between the adjacent beams, the satellite BS of the satellite communication system provides the service to the first terminals 802 existing within each beam sector through the single beam for each beam sector in the first subcarrier group areas 602, 604, 606 and 608 described above with reference to FIG. 6. Furthermore, in order to maximize the frequency use efficiency through the frequency reuse and minimize the interference between the adjacent beams, the CTC provides the service to the second terminals 804 existing within each beam sector through the multi-beams in the second subcarrier group areas 610, 614, 618 and 622 and the third subcarrier group areas 612, 616 and 620 described above with reference to FIG. 6.

The CTC confirms the channel state of the second terminal 804 according to the position information and the moving speed information of the second terminal 804, and determines the coverage size of the beam providing the service to the second terminal 804 according to the confirmed channel state of the second terminal 804. More specifically, according to the position of the first terminal 802, for example, when the first terminal 802 exists within the multi-beams of the CTC, that is, when the second terminal 804 receives the signal transmitted from the satellite BS, the second terminal 804 receives the service from the CTC through the multi-beams in the third subcarrier group areas 612, 616 and 620 of FIG. 6 in order to minimize the interference between the signal transmitted to the first terminal 802 and the signal transmitted to the second terminal 804. When the first terminal 802 does not exist within the multi-beams of the CTC, that is, when the second terminal 804 does not receive the signal transmitted from the satellite BS, no interference occurs between the signals transmitted from the satellite BS and the CTC. Thus, the second terminal 804 receives the service from the CTC through the multi-beams in the second subcarrier group areas 610, 614, 618 and 622 of FIG. 6.

Also, the CTC confirms the traffic requirements of the second terminal 804 in each beam sector, that is, the service type to be received, and the position, speed or channel information, determines the priority according to the required QoS or the channel states of the terminals, and selects an optimum terminal. The CTC allocates the access slots to each beam sector according to the channel state of the selected terminal, that is, determines the coverage size such as the beam angles of the multi-beams. At this time, the total power of each beam radiated in each beam sector is lower than the usable maximum power of the CTC, and the satellite communication system determines the powers and angles of the multi-beams, that is, the power, the coverage size and the beam directions of the multi-beams, in order to maximize the capacity of all beam access which performs the beam division multiple access with the terminals existing in each beam sector.

The CTCs existing within the respective service areas 810, 830 and 860 share communication information of the access slots through the multi-beams of the CTCs existing within the adjacent service areas, that is, information about the subcarrier groups used in the access slots, and information about the power, the coverage size and the beam directions of the multi-beams. In order to minimize the interference between the adjacent beams of the CTC by using the information shared by the CTCs existing within the adjacent service areas, the CTC determines the power and angle of the beams, that is, the power, the coverage size and the beam directions of the multi-beams.

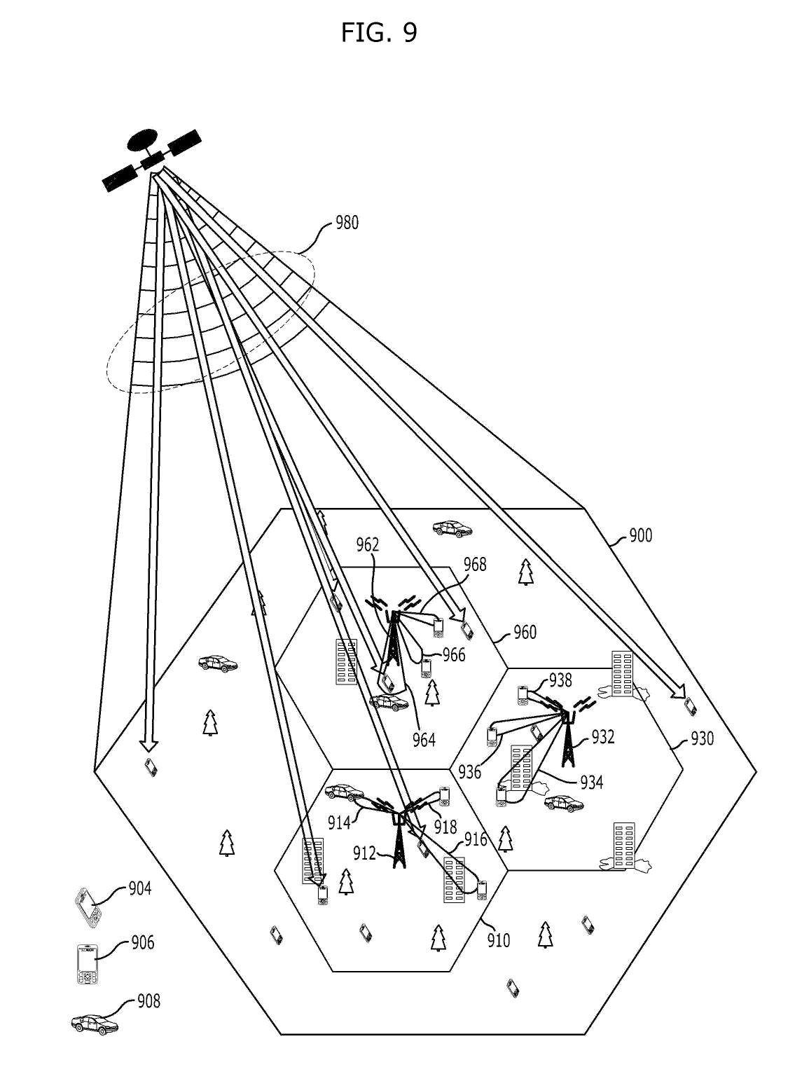

Furthermore, the CTC determines the coverage size and power of the multi-beams, considering a total number of the second terminals 804 existing within the beam sector, a maximum power usable when the CTC transmits the signal through the multi-beams, an antenna gain when the signal is transmitted to the second terminal 804 through the multi-beams of the CTC, a channel state between the multi-beams of the CTC and the second terminal 804, and a channel state, an antenna gain and a transmission power between the multi-beams of the satellite BS and the second terminal 804, an antenna state, a transmission power, the number of the service areas where the adjacent CTCs exist, the number of the terminals in each service area, a channel state, a transmission power and antenna gain between the adjacent CTCs and the corresponding terminal. That is, the total power of each beam radiated to each beam sector is lower than the maximum usable power of the CTC, and the power and angle of the multi-beams, that is, the power, the coverage size and the beam direction of the multi-beams are determined to maximize the capacity of all beam accesses in which the terminals existing at each beam sector performs a beam division multiple access. Although the service provided by the CTCs existing within the adjacent service areas, and the beam coverage size and power when providing the service have been described above, the invention can also be equally applied to the CTCs existing the adjacent beam sectors which are not the adjacent service areas. A beam pattern of the multi-beams when the satellite BS and the CTC provide the service through the multi-beams to the terminals existing within the service areas in the satellite communication system in accordance with the embodiment of the present invention will be described in more detail with reference to FIG. 9.

FIG. 9 is a diagram schematically illustrating another beam pattern of the satellite communication system in accordance with the embodiment of the present invention. Specifically, FIG. 9 is a diagram schematically illustrating an environment in which a satellite BS and a CTC provide a service to a plurality of terminals existing within a general service area, based on multi-beams.

Referring to FIG. 9, when providing a service to a wide service area 900 based on multi-beams, the satellite communication system divides the service area 900 into a plurality of beam sectors according to the multi-beams formed by an array antenna. For example, the satellite communication system divides the service area 900 into a first beam sector 910, a second beam sector 930, and a third beam sector 960. For convenience of explanation, it is assumed that one CTC exists in each divided beam sector, that is, a first CGC 912, a second CGC 932, and a third CGC 962 exist in the first beam sector 910, the second beam sector 930, and the third beam sector 960, respectively.

In order to minimize the interference between the adjacent beams and maximize the frequency use efficiency through the frequency reuse within the service area 900 through the multi-beams 980, the satellite BS of the satellite communication system provides the service to the first terminals 904 existing within the service area 900 through first subcarrier group areas 602, 604, 606 and 608 described above with reference to FIG. 6.

In order to minimize the interference with the signal transmitted to the first terminals 904 by the satellite BS and maximize the frequency use efficiency through the frequency reuse within the beam sectors 910, 930 and 960 through the multi-beams 914, 916, 918, 934, 936, 938, 964, 966 and 968, the CGCs 912, 932 and 962 existing within each beam sector CTC provide the service to the second terminals 906 and 908 existing within the beam sectors 910, 930 and 960 through the second subcarrier group areas 610, 614, 618 and 622 and the third subcarrier group areas 612, 616 and 620 described above with reference to FIG. 6.

More specifically, the CGCs 912, 932 and 962 confirm the channel states of the second terminals 906 and 908 by acquiring the position information and the moving speed information of the second terminals 906 and 908 existing within the beam sectors 910, 930 and 960, and determines the coverage size of the beam providing the service to the second terminals 906 and 908 according to the confirmed channel states of the second terminals 906 and 908. According to the position of the first terminal 904, for example, when the first terminal 904 exists within the multi-beams of the CGCs 912, 932 and 962, that is, when the second terminals 906 and 908 receive the signal transmitted from the satellite BS, the second terminals 906 and 908 receive the service from the CGCs 912, 932 and 962 through the multi-beams in the third subcarrier group areas 612, 616 and 620 of FIG. 6 in order to minimize the interference between the signal transmitted to the first terminal 904 and the signal transmitted to the second terminals 906 and 908. When the first terminal 904 does not exist within the multi-beams of the CGC, that is, when the second terminals 906 and 908 do not receive the signal transmitted from the satellite BS, no interference occurs between the signals transmitted from the satellite BS and the CGCs 912, 932 and 962. Thus, the second terminals 906 and 908 receive the service from the CGCs 912, 932 and 962 through the multi-beams in the second subcarrier group areas 610, 614, 618 and 622 of FIG. 6.

Also, the CGCs 912, 932 and 962 confirm the traffic requirements of the second terminals 906 and 908 in each beam sector, that is, the service type to be received, and the position, speed or channel information, determines the priority according to the required QoS or the channel states of the terminals, and selects an optimum terminal. The CGCs 912, 932 and 962 allocate the access slots to each beam sector according to the channel state of the selected terminal, that is, determines the coverage size such as the beam angles of the multi-beams. At this time, the total power of each beam radiated in each beam sector is lower than the usable maximum power of the CGCs 912, 932 and 962, and the satellite communication system determines the powers and angles of the multi-beams, that is, the power, the coverage size and the beam directions of the multi-beams, in order to maximize the capacity of all beam access which performs the beam division multiple access with the terminals existing in each beam sector.

The CGCs 912, 932 and 962 existing within the respective beam sectors 910, 930 and 960 share communication information of the access slots through the multi-beams of the CGCs existing within the adjacent beam sectors, that is, information about the subcarrier groups used in the access slots, and information about the power, the coverage size and the beam directions of the multi-beams. In order to minimize the interference between the adjacent beams of the CTC by using the information shared by the CTCs existing within the adjacent service areas, the CGCs 912, 932 and 962 determine the power and angle of the beams, that is, the power, coverage size and beam directions of the multi-beams.

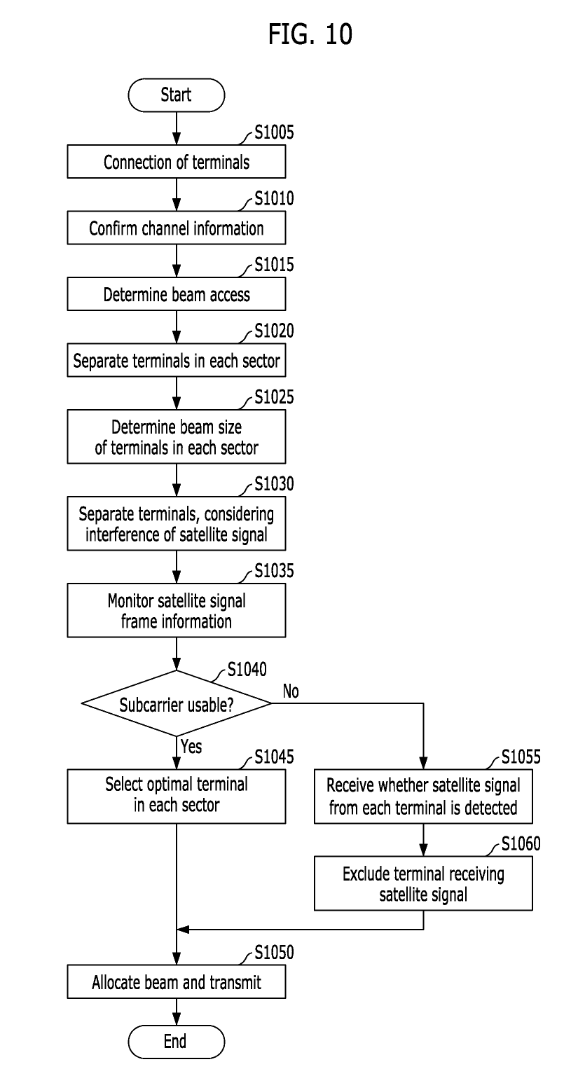

Furthermore, the CGCs 912, 932 and 962 determine the coverage size and power of the multi-beams, considering a total number of the second terminals 906 and 908 existing within the beam sector, a maximum power usable when the CGC transmits the signal through the multi-beams, an antenna gain when the signal is transmitted to the second terminals 906 and 908 through the multi-beams of the CGC, a channel state between the multi-beams of the CGC and the second terminals 906 and 908, and a channel state, an antenna gain and a transmission power between the multi-beams 980 of the satellite BS and the second terminals 906 and 908, an antenna state, a transmission power, the number of the beam sectors where the adjacent CGCs exist, the number of the terminals in each beam sector, a channel state, a transmission power and antenna gain between the adjacent CGCs and the corresponding terminal. That is, the total power of each beam radiated to each beam sector is lower than the maximum usable power of the CGC, and the power and angle of the multi-beams, that is, the power, the coverage size and the beam direction of the multi-beams are determined to maximize the capacity of all beam accesses in which the terminals existing at each beam sector performs a beam division multiple access. The operation of providing the service through the multi-beams in the satellite communication system in accordance with the embodiment of the present invention will be described in more detail with reference to FIG. 10.

FIG. 10 is a flowchart schematically illustrating a method for providing a service in a satellite communication system in accordance with an embodiment of the present invention.

Referring to FIG. 10, terminals existing within the service area and intended to receive the communication service are initially connected at step S1005. At step S1010, the position information and the moving speed information of the connected terminals are acquired in the above-described manner, and the channel states of the terminals are confirmed through the acquired information. Since the operation of acquiring the position information and the moving speed information of the terminals and confirming the channel states has been described in more detailed, further description thereof will be omitted.

At step S1015, the satellite communication system divides the service area into the plurality of access slots, that is, the plurality of beam sectors, according to the multi-beams, and provides the service by performing the communication through one beam in each sector. At step S1020, the satellite communication system separates the terminal (that is, the first terminal) which receives the service from the satellite BS through the communication with the satellite BS, from the terminal (that is, the second terminal) which receives the service from the CTC through the communication with the CTC, considering the position information and the moving speed information of the terminals existing within each beam sector.

At step S1025, the satellite communication system determines the power and angle of the multi-beams providing the service to the terminals, that is, the power, the coverage size and the beam directions of the multi-beams, in order to provide the service to the terminals confirmed in each beam sector, based on the multi-beams. Since the operation of determining the coverage size of the multi-beams has been described in detailed, further description thereof will be omitted.

At step S1030, the satellite communication system separates the terminal (that is, the second terminal) which receives the signal transmitted from the satellite BS to the first terminal, from the second terminal which does not receive the signal transmitted to the first terminal, among the second terminals which perform the communication with the CTC in each beam sector. The separation of the second terminals within the beam sectors, considering the signal transmitted by the satellite BS, that is, the satellite signal, is performed through the position information of the second terminals. When the second terminal receives the signal from the CTC in order for providing the service, the terminals are separated into terminals in which interference occurs due to the signal transmitted by the satellite BS and terminals in which interference does not occur. Thus, the service is provided to the second terminals while minimizing the interference between the signals transmitted from the satellite BS and the signals transmitted from the CTC.

At step S1035, when the service is provided through the frame described in FIG. 4 or 6, in particular, the frame described in FIG. 6 in order to provide the service by using the CTC, the satellite communication system monitors transmission frame information. As described in FIG. 6, the frame includes the first subcarrier group areas 610, 614, 618 and 622 allocated for signal transmission to the first terminals when providing the service of the satellite BS, and the second subcarrier group areas 610, 614, 618 and 622 and the third subcarrier group areas 612, 616 and 620 allocated for signal transmission to the second terminals.

At step S1040, the satellite communication system confirms the existence of the subcarriers or subcarrier group usable in the transmission frame in order for providing the service to the first terminals and the second terminals which are separated in each beams sector. In other words, when the subcarrier group areas of FIG. 6 are allocated for providing the service to the terminals existing within the beam sectors, the satellite communication system confirms whether the subcarriers usable for the signal transmission to the terminals exist in the subcarrier group areas of FIG. 6.

At step S1045, when it is determined at the step S1040 that the subcarriers or subcarrier group exists, the satellite communication system determines the priority according to the required QoS or the channel states of the terminals existing in each beam sector, and selects an optimum terminal in each beam sector.

At step S1050, the satellite communication system allocates the access slots in each beam sector according to the channel state of the selected terminal, that is, determines the coverage size such as the beam angles of the multi-beams. At this time, the total power of each beam radiated in each beam sector is lower than the usable maximum power of the CTC, and the satellite communication system determines the powers and angles of the multi-beams, that is, the power, the coverage size and the beam directions of the multi-beams, in order to maximize the capacity of all beam access which performs the beam division multiple access with the terminals existing in each beam sector.

Accordingly, the satellite communication system allocates the resources and power of the multi-beams for providing the service through the satellite BS and the CTC, and then transmits the signal to provide the service. The first terminals receives the service through the multi-beams of the satellite BS in the first subcarrier group areas 602, 604, 606 and 608, and the second terminal receiving the transmission signal of the satellite BS receives the service through the multi-beams of the CTC in the third subcarrier group areas 612, 616 and 620. The second terminals which do not receive the transmission signal of the satellite BS receives the service through the multi-beams of the CTC in the second subcarrier group areas 610, 614, 618 and 622.

Meanwhile, at step S1055, when it is determined at the step S1040 that the subcarriers or subcarrier group does not exist, the satellite communication system confirms the terminals existing within the beam sectors, in particular, the second terminals which receive the signals transmitted from the satellite BS to the first terminals. At step S1060, the remaining second terminals except for the second terminals which have received the signals transmitted from the satellite BS, that is, the second terminals which have not received the signals transmitted from the satellite BS, receive the service through the multi-beams of the CTC in the first subcarrier group areas 602, 604, 606 and 608.

At step S1050, the satellite communication system determines the power, the coverage size and the beam directions of the multi-beams, allocates the resources and power of the multi-beams for providing the service through the satellite BS and the CTC, and transmits the signals through the usable subcarriers or subcarrier group to the first terminals and the second terminals existing within the service area. In this way, the satellite communication system provides the service.

In accordance with the exemplary embodiments of the present invention, when providing the service based on the multi-beams, the satellite communication system provides the communication service while distinguishing the beam center area and the beam boundary area formed by the multi-beams. Thus, the service can be stably provided while minimizing the beam interference occurring in the multi service area and the plurality of users. Also, when providing the service through the limited resources, the satellite communication system provides the service while distinguishing the beam center area and the beam boundary area in order to minimize the beam interference. Accordingly, the divided use of the limited resources is minimized to thereby maximize the use efficiency of the limited resources. Furthermore, when providing the service based on the multi-beams by using the CTC, the satellite communication system can minimize the interference between the signals transmitted to the terminals and maximize the frequency use efficiency by applying the beam division multiple access to the CTCs existing in the beam center area and the beam boundary area formed by the multi-beams.

While the present invention has been described with respect to the specific embodiments, it will be apparent to those skilled in the art that various changes and modifications may be made without departing from the spirit and scope of the invention as defined in the following claims.

What is claimed is:

1. A service providing method in a satellite communication system, comprising:
confirming positions of terminals when the terminals existing within a service area and intended to receive a service is connected to a satellite base station or a complementary terrestrial component;
confirming first terminals, which communicate with the satellite base station, and second terminals, which communicate with the complementary terrestrial component, according to the positions of the terminals;
allocating resources usable when communicating with the first terminals and resources usable when communicating with the second terminals; and
providing a service to the terminals by using the allocated resources through multi-beams of the satellite base station and multi-beams of the complementary terrestrial component.

2. The service providing method of claim 1, wherein said allocating resources usable when communicating with the first terminals and resources usable when communicating with the second terminals comprises:
dividing the service area into a plurality of beam sectors according to the multi-beams of the satellite base station; and
dividing subcarriers of a usable frequency usable in the service area into a plurality of subcarrier groups.

3. The service providing method of claim 2, wherein, in said allocating resources usable when communicating with the first terminals and resources usable when communicating with the second terminals,
all subcarriers of the usable frequency to center areas of the beam sectors, and the subcarrier groups different from the subcarrier groups allocated to center areas of adjacent beam sectors are allocated to edge areas of the beam sectors, in order for communication through the multi-beams of the satellite base station.

4. The service providing method of claim 2, wherein, in said allocating resources usable when communicating with the first terminals and resources usable when communicating with the second terminals,
the remaining subcarrier groups except for the subcarrier group allocated to an edge area of a predetermined beam sector in order for communication through the multi-beams of the satellite base station are allocated to a center area of the predetermined beam sector among the beam sectors, and the subcarrier group different from the subcarrier groups allocated to an edge area of adjacent beam sectors among the remaining subcarrier groups is allocated to an edge area of the predetermined beam sector, in order for communication through the multi-beams of the complementary terrestrial component.

5. The service providing method of claim 2, wherein said allocating resources usable when communicating with the first terminals and resources usable when communicating with the second terminals comprises dividing a subcarrier of a predetermined frequency band, which is usable when providing the service to the terminals, into a plurality of subcarrier groups.

6. The service providing method of claim 5, wherein, in said allocating resources usable when communicating with the first terminals and resources usable when communicating with the second terminals
all subcarrier groups are allocated to center areas of the beam sectors, and the subcarrier groups different from the subcarrier groups allocated to an edge area of adjacent beam sectors are allocated to edge areas of the beam sectors.

7. The service providing method of claim 5, wherein said allocating resources usable when communicating with the first terminals and resources usable when communicating with the second terminals comprises:
spacing the predetermined frequency band at a predetermined interval, and dividing the subcarrier of the predetermined frequency band into a first subcarrier group and a second subcarrier group at the same frequency band; and
dividing the subcarrier existing in the frequency band of the predetermined interval into a third subcarrier group.

8. The service providing method of claim 7, wherein, in said allocating resources usable when communicating with the first terminals and resources usable when communicating with the second terminals,
the first subcarrier group is allocated in order for communication through the multi-beams of the satellite base station, and
the second subcarrier group and the third subcarrier group are allocated in order for communication through the multi-beams of the complementary terrestrial component.

9. The service providing method of claim 8, wherein said allocating resources usable when communicating with the first terminals and resources usable when communicating with the second terminals comprises:
confirming a terminal which receives a transmission signal through the multi-beams of the satellite base station among the second terminals according to the positions of the second terminals;
allocating the third subcarrier group in order for communication with the terminal which receives the transmission signal; and
allocating the second subcarrier group in order for communication with the terminal which does not receive the transmission signal.

10. The service providing method of claim 1, wherein channel states and Quality of Service (QoS) of the terminals are confirmed by acquiring position information and moving speed information of the terminals through a Global Positioning System (GPS) or information about channels to which the terminals are connected.

11. The service providing method of claim 10, wherein said allocating resources usable when communicating with the first terminals and resources usable when communicating with the second terminals comprises:
determining a priority according to the channel states and the QoS of the terminals, and selecting an optimal terminal among the terminals; and
determining the coverage size and power of the multi-beams of the satellite base station and the multi-beams of the complementary terrestrial component within the service area according to the channel state of the selected terminal.

12. A service providing system in a satellite communication system, comprising:
a plurality of terminals existing within a service area and connecting the satellite communication system to receive a service;
a satellite base station configured to support a first communication between the satellite communication system and terminals intended to receive the service within the service area, confirm first terminals performing the first communication according to positions of the terminals, form a first multi-beam for performing the first communication, and provide a service to the first terminals through the first multi-beam as a resource usable when communicating with the first terminals; and
a complementary terrestrial component existing within the service area and configured to support a second communication between the terminals and the satellite communication system, confirm second terminals performing the second communication according to positions of the terminals, form a second multi-beam for performing the second communication, and provide a service to the second terminals through the second multi-beam as a resource usable when communicating with the second terminals.

13. The service providing system of claim 12, wherein the satellite base station is configured to divide the service area into a plurality of beam sectors according to the first multi-beam, and divide a subcarrier of a frequency usable in the service area into a plurality of subcarrier groups.

14. The service providing system of claim 13, wherein, in order for the first communication, the satellite base station provides a service by allocating all subcarriers of the usable frequency to center areas of the beam sectors, and provides a service by allocating the subcarrier groups, which are different from the subcarrier groups allocated to center areas of adjacent beam sectors, to edge areas of the beam sectors.

15. The service providing system of claim 13, wherein, in order for the second communication, the satellite base station allocates the remaining subcarrier groups, except for the subcarrier group allocated to an edge area of a predetermined beam sector in order for the first communication, to a center area of the predetermined beam sector among the beam sectors, and allocates the subcarrier group different from the subcarrier groups, which are allocated to an edge area of adjacent beam sectors among the remaining subcarrier groups, to an edge area of the predetermined beam sector, and
the complementary terrestrial component provides a service to the second terminals through the second multi-beam as the allocated subcarrier group.

16. The service providing system of claim 13, wherein the satellite base station is configured to divide a subcarrier of a predetermined frequency band, which is usable when providing the service to the terminals, into a plurality of subcarrier groups, provide the service by allocating all subcarrier groups to center areas of the beam sectors, and provide the service by allocating the subcarrier groups different from the subcarrier groups, which are allocated to an edge area of adjacent beam sectors, to edge areas of the beam sectors, in order for the first communication.

17. The service providing system of claim 16, wherein the satellite base station is configured to space the predetermined frequency band at a predetermined interval, and divide the subcarrier of the predetermined frequency band into a first subcarrier group and a second subcarrier group at the same frequency band, and divide the subcarrier existing in the frequency band of the predetermined interval into a third subcarrier group.

18. The service providing system of claim 17, wherein the satellite base station is configured to provide the service through the first subcarrier group, and
the complementary terrestrial component is configured to confirm a terminal which receives a transmission signal of the satellite base station among the second terminals according to the positions of the second terminals, provide the service through the third subcarrier group to the terminal which receiving the transmission signal, and provide the service through the second subcarrier group to the terminal which does not receive the transmission signal.

19. The service providing system of claim 12, wherein the complementary terrestrial component is configured to confirm channel states and Quality of Service (QoS) of the terminals by acquiring position information and moving speed information of the terminals through a Global Positioning System (GPS) or information about channels to which the terminals are connected.

20. The service providing system of claim 19, wherein the complementary terrestrial component is configured to determine a priority according to the channel states and the QoS of the terminals, select an optimal terminal among the terminals, and determine the coverage size and power of the second multi-beam within the service area according to the channel state of the selected terminal.
